(19) United States
(12) Patent Application Publication
(10) Pub. No.: US 2024/0421937 A1
(43) Pub. Date: Dec. 19, 2024

(54) FAST RETRANSMISSION MECHANISMS TO MITIGATE STRAGGLERS AND HIGH TAIL LATENCIES FOR RELIABLE OUT-OF-ORDER TRANSPORT PROTOCOLS

(71) Applicant: Microsoft Technology Licensing, LLC, Redmond, WA (US)

(72) Inventors: Mohammad Saifee DOHADWALA, Redmond, WA (US); David Andreas SIDLER, Seattle, WA (US); Michael Konstantinos PAPAMICHAEL, Redmond, WA (US)

(73) Assignee: Microsoft Technology Licensing, LLC, Redmond, WA (US)

(21) Appl. No.: 18/210,573

(22) Filed: Jun. 15, 2023

(51) Int. Cl. H04L 1/18; H04L 45/24; H04L 45/74; H04L 47/34; H04L 69/22; H04L 69/326

(52) U.S. Cl. CPC H04L 1/18; H04L 45/24; H04L 45/74; H04L 47/34; H04L 69/22; H04L 69/326

(57) ABSTRACT

As part of managing delivery of a given packet flow according to a reliable transport protocol, a sender sends, to a receiver, a last flow packet among multiple flow packets of a flowlet. After sending the last flow packet but before satisfaction of a timeout condition for the last flow packet, the sender sends one or more end-of-flowlet (“EOF”) packets, which can be flush packets, query packets, or another type of packet. The sender receives, from the receiver, feedback metadata for the EOF packet(s) and updates a tracking window based at least in part on the feedback metadata. The sender selectively resends one or more unacknowledged flow packets according to the updated tracking window. In this way, the sender can quickly address any dropped packets or significantly delayed packets at the end of a flowlet, without waiting for the timeout condition to detect the dropped or delayed packets.

### BACKGROUND

In computer networking, a transport protocol is a set of rules and procedures that govern the exchange of data between computing devices over a computer network. Typically, one of the computing devices, acting as a sender, breaks data such as a message or file into smaller units called packets. The sender sends the packets over the computer network to another computing device, which has the role of a receiver and can recreate the data from information in the packets.

A transport protocol interoperates with network protocols at other layers. For example, an implementation of a transport layer receives data such as a message or file from an implementation of an application layer, presentation layer, or session layer. The implementation of the transport layer provides transport-layer packets for the data to an implementation of a network layer, which can implement a version of Internet Protocol (“IP”). Depending on the transport protocol, transport-layer processing can provide features such as error detection, retransmission of dropped transport-layer packets, control over the rate that transport-layer packets are transmitted (sometimes called flow control), and sequencing of transport-layer packets. Transmission control protocol (“TCP”) and user datagram protocol (“UDP”) are two examples of transport protocols.

A reliable transport protocol uses mechanisms to guarantee, or at least take steps to guarantee, the delivery of transport-layer packets from the sender to the receiver. Such mechanisms can include error detection, retransmission of dropped packets, and flow control. TCP is an example of a reliable transport protocol. The mechanisms that provide for reliable delivery of transport-layer packets can add delay to detect and retransmit dropped packets, which may be significant if many transport-layer packets are dropped. UDP is an example of an unreliable transport protocol. UDP can provide more timely delivery of transport-layer packets, without the overhead of reliability mechanisms but also without the attempts to guarantee delivery.

Some reliable transport protocols support only single-path delivery of transport-layer packets of a flow from a sender to a receiver. For single-path delivery, the packets of the flow are delivered over a single path through a network. In a simple network, there might be only a single path between the sender and the receiver. More commonly, the network has multiple potential paths between the sender and receiver, but routing mechanisms (such as conventional equal cost multi-path (“ECMP”) hashing mechanisms) cause packets that belong to the same flow to take the same path. Because the flow packets all travel along the same path, the flow packets are assumed to arrive at the receiver in the same order that the flow packets are sent by the sender.

In contrast, other reliable transport protocols support multi-path delivery of transport-layer packets of a flow from a sender to a receiver. For multi-path delivery, different packets of the flow are delivered over different, alternative paths of a computer network. By delivering packets of a flow on multiple paths of the network, the available bandwidth of the network can be more consistently and evenly used. The amount of delay on different paths can vary, however. For example, a switch may be temporarily busy, causing delay in delivery of packets through that switch. Because of different delays along different paths, packets are frequently received by the receiver in an order different than the order the packets were sent by the sender.

In extreme cases, a packet may be dropped due to congestion at a switch. Rarely, bits of a packet may suffer from bit flips due to interference, an unreliable link, or another cause, resulting in the packet being dropped when loss of information is detected. A sender can retransmit a dropped packet.

Some previous reliable transport protocols provide some support for out-of-order (“OOO”) delivery of transport-layer packets over multiple paths of a network. In particular, some previous reliable transport protocols allow for variations in delay in delivery of a transport-layer packet, such that the packet can be delivered OOO so long as the delayed packet is received within a defined window. By waiting to resend a packet, which might have been dropped or might have merely been delayed, the sender provides additional time for the packet to arrive and avoids unnecessary retransmission of the packet. Eventually, however, after a significant delay, the sender can decide that a delayed packet has actually been dropped, and the sender retransmits the dropped packet. In extreme cases, the sender may stall-unable to send other packets-until the dropped packet is retransmitted and acknowledged as received.

In many usage scenarios, previous approaches to retransmission of packets do not work well for packets at the end of a flowlet. A flowlet is a burst of multiple packets from a given packet flow. The burst is followed by an idle interval. Typical approaches have a retransmission mechanism to manage delivery of packets before the end of a flowlet but rely on a timeout condition for packets at the end of the flowlet. The timeout condition can accurately indicate whether a packet has been dropped or delayed, but the timeout condition can be very slow to react to actual packet drops.

### SUMMARY

In summary, the detailed description presents innovations in operations of a reliable out-of-order transport protocol with fast retransmission of packets at the end of a flowlet. With the fast retransmission mechanism, a sender can quickly address any dropped or significantly delayed packets at the end of a flowlet, without waiting for a timeout condition to detect the dropped or delayed packets. This allows the sender to complete delivery of the packets of the flowlet more quickly.

According to a first set of techniques and tools described herein, as part of managing delivery of a given packet flow according to a reliable transport protocol, a sender sends, to a receiver across a network, a last transport-layer flow packet of a flowlet. The flowlet is a burst of multiple transport-layer flow packets from the given packet flow, followed by an idle interval. The multiple transport-layer flow packets of the flowlet end with the last transport-layer flow packet. In some example implementations, the reliable transport protocol supports multi-path delivery of the flow packets over multiple paths of the network. In other example implementations, the reliable transport protocol supports single-path delivery of the flow packets over a single path of the network.

After sending the last flow packet but before satisfaction of a timeout condition for the last flow packet, the sender sends one or more end-of-flowlet (“EOF”) packets. An EOF packet can be a flush packet, query packet, or other type of packet. In some example implementations, the flow packets and the EOF packet(s) (at least when the EOF packets are flush packets) are ordered by packet sequence number (“PSN”) in a packet sequence. The EOF packet(s) immediately follow the last transport-layer flow packet in the packet sequence. The sender can send an initial EOF packet, among the EOF packet(s), right after sending the last flow packet, without sending any other packets between the last flow packet and the initial EOF packet. For example, the sender sends the initial EOF packet less than a target time after sending the last flow packet. The target time can be a time less than a round trip time expected for the multiple flow packets, or the target time can be set in some other way.

The sender can selectively send EOF packet(s). For example, the sender determines a metric that quantifies activity level. The metric can depend on the amount of data ready to send at the sender to the receiver for the given packet flow and/or depend on another factor. The sender compares the metric to a threshold. The sending of the EOF packet(s) is contingent on the metric satisfying the threshold. In this way, the sender can skip sending EOF packets if the network is already busy or likely to be busy, or if the sender will soon send flow packets to the receiver that should trigger feedback metadata. Alternatively, the sender can automatically send at least some EOF packets.

The sender receives, from the receiver, feedback metadata for the EOF packet(s). The sender updates a tracking window based at least in part on the feedback metadata for the EOF packet(s). For example, the feedback metadata for the EOF packet(s) includes selective acknowledgement (“SACK”) metadata for one or more of the sent flow packets. In particular, the feedback metadata can indicate a given sent flow packet has been received. In this case, the tracking window is updated by changing an indicator bit for the given sent flow packet to indicate the given sent flow packet has been received.

The sender selectively resends, to the receiver across the network, one or more unacknowledged flow packets, according to the updated tracking window, among the sent flow packets of the flowlet. For example, the sender evaluates a condition using the updated tracking window. Responsive to determining that the condition is satisfied, the sender resends the unacknowledged flow packet(s) to the receiver. Or, responsive to determining that the condition is not satisfied, the sender skips resending the unacknowledged flow packet(s) to the receiver.

In some example implementations, each of the EOF packet(s) is a transport-layer flush packet having a header and a payload. The payload of the flush packet can be nominal or empty. When the reliable transport protocol supports multi-path delivery of the flow packets over multiple paths of the network, the tracking window is an out-of-order (“OOO”) tracking window that tracks n packets, where n is greater than 1. The sender sends up to n EOF packets so as to flush the OOO tracking window. When the sender selectively resends unacknowledged flow packet(s) of the flowlet, the sender identifies the unacknowledged flow packet(s) in the updated OOO tracking window and resends the identified flow packet(s). Alternatively, when the reliable transport protocol supports single-path delivery of the flow packets over a single path of the network, the tracking window is an in-order tracking window. The sender sends a single EOF packet so as to flush the in-order tracking window. When the sender selectively resends unacknowledged flow packet(s) of the flowlet, the sender determines that the last flow packet has been delayed or dropped, and resends the last flow packet.

In other example implementations, each of the EOF packet(s) is a transport-layer query packet having a header and a payload. An indicator in the header of the query packet marks the query packet as a special class of packet that requests delivery state information from the receiver. The payload of the query packet can be nominal or empty. When the reliable transport protocol supports multi-path delivery of the flow packets over multiple paths of the network, the tracking window is an OOO tracking window that tracks n packets, where n is greater than 1. According to a query interval, the sender periodically sends one of the EOF packets until all of the sent flow packets of the flowlet have been acknowledged as received. For example, the query interval is set to be half the expected round trip time (“RTT”) for the flow packets.

The payload of an EOF packet can be empty or nominal, such that the EOF packet(s) do not significantly contribute to network congestion. Alternatively, a given EOF packet can have the payload of a given flow packet, among the sent flow packets of the flowlet, that has not been acknowledged as received. In this case, the feedback metadata can indicate the given flow packet has been received or indicate the given EOF packet has been received. Either way, the tracking window is updated by changing an indicator bit for the given flow packet to indicate the given flow packet has been received.

According to a second set of techniques and tools described herein, as part of managing delivery of a packet flow according to a reliable transport protocol, a sender sends, to a receiver across a network, a last transport-layer flow packet of a flowlet. The reliable transport protocol can support multi-path delivery or single-path delivery of the flow packets.

After sending the last flow packet but before satisfaction of a timeout condition for the last flow packet, the sender selectively resends one or more of the sent flow packets of the flowlet that have not yet been acknowledged as received according to a tracking window. For example, the reliable transport protocol supports multi-path delivery of the flow packets over multiple paths of the network, and the tracking window is OOO tracking window that tracks n packets, n being greater than 1. By selectively resending sent transport-layer flow packet(s) of the flowlet that have not yet been acknowledged as received, the sender can more quickly fill any holes in the OOO tracking window. The sender receives, from the receiver, feedback metadata, and updates the tracking window based at least in part on the feedback metadata. The sender can then selectively resend, to the receiver across the network, one or more unacknowledged flow packets, according to the updated tracking window, among the sent flow packets of the flowlet.

The innovations described herein can be implemented as part of a method, as part of a computer system (physical or virtual, as described below) or network interface device configured to perform the method, or as part of a tangible computer-readable media storing computer-executable instructions for causing one or more processors, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIG. 1 is a diagram illustrating an example computer system in which some described embodiments can be implemented.

FIG. 2 is a diagram of example transport-layer processing in conjunction with which some described embodiments can be implemented.

FIG. 3 is a diagram of an example network in which some described embodiments can be implemented.

FIG. 4 is a listing that illustrates delivery of packets of an example packet sequence (400) according to a reliable transport protocol that supports multi-path delivery.

FIGS. 5a-5c are diagrams showing states of an example OOO tracking window at three different times for the example packet sequence of FIG. 4.

FIG. 6 is a listing that illustrates delivery of packets of an example packet sequence according to a reliable transport protocol with delayed retransmission at the end of a packet flowlet.

FIG. 7 is a listing that illustrates delivery of packets of an example packet sequence according to a reliable transport protocol with selective quick retransmission of packets at the end of a packet flowlet.

FIG. 8 is a listing that illustrates delivery of packets of an example packet sequence according to a reliable transport protocol that uses flush packets at the end of a packet flowlet.

FIG. 9 is a listing that illustrates delivery of packets of an example packet sequence according to a reliable transport protocol that uses query packets at the end of a packet flowlet.

FIG. 10 is a flowchart illustrating a generalized technique for delivery of packets according to a reliable transport protocol with selective fast retransmission of packets at the end of a packet flowlet.

FIG. 11 is a flowchart illustrating a generalized technique for delivery of packets according to a reliable transport protocol with fast retransmission using EOF packets.

### DETAILED DESCRIPTION

The detailed description presents innovations in operations of a reliable transport protocol with fast retransmission of packets at the end of a flowlet. The flowlet is a burst of multiple transport-layer flow packets from a packet flow, followed by an idle interval. For example, as part of managing delivery of a packet flow according to a reliable transport protocol, a sender sends, to a receiver across a network, a last transport-layer flow packet among multiple transport-layer flow packets for the flowlet. After sending the last flow packet but before satisfaction of a timeout condition for the last flow packet, the sender sends one or more end-of-flowlet (“EOF”) packets, which can be flush packets, query packets, or another type of packet. The sender can send an initial EOF packet right after sending the last flow packet, without sending any other packets between the last flow packet and the initial EOF packet. The sender receives, from the receiver, feedback metadata for the EOF packet(s) and updates a tracking window based at least in part on the feedback metadata for the EOF packet(s). The sender selectively resends, to the receiver across the network, one or more unacknowledged flow packets, according to the updated tracking window, among the sent flow packets of the flowlet. In this way, the sender can quickly address any dropped or significantly delayed packets at the end of a packet flowlet, without waiting for the timeout condition to detect the dropped or delayed packets at the end of the flowlet. This allows the sender to complete delivery of the packets of the flowlet more quickly.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique or tool does not solve all such problems. It is to be understood that other examples may be utilized and that structural, logical, software, hardware, and electrical changes may be made without departing from the scope of the disclosure. The following description is, therefore, not to be taken in a limited sense.

### I. Example Computer Systems.

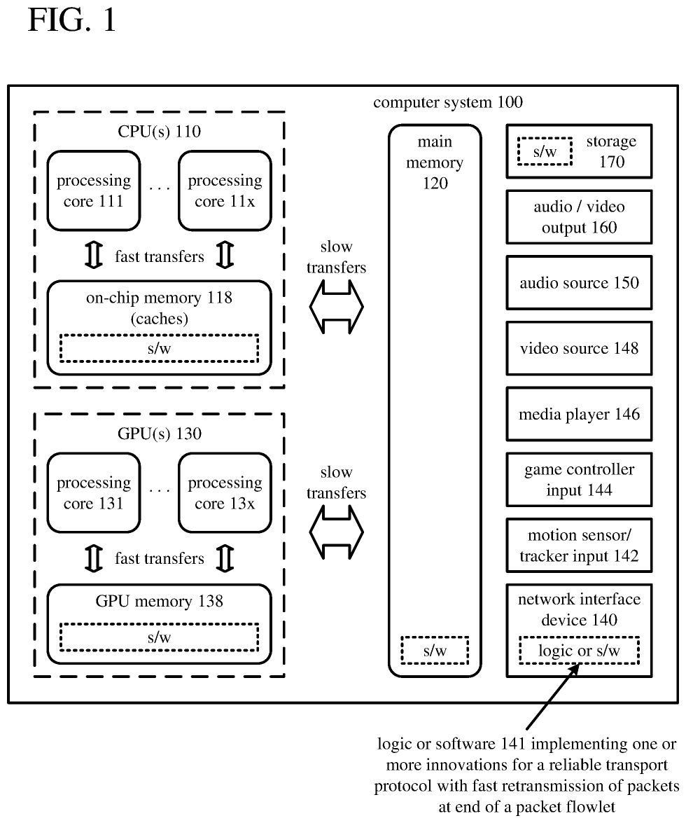

FIG. 1 illustrates a generalized example of a suitable computer system (100) in which several of the described innovations may be implemented. The innovations described herein relate to a reliable transport protocol with fast retransmission of flow packets at the end of a flowlet. The computer system (100) is not intended to suggest any limitation as to scope of use or functionality, as the innovations may be implemented in diverse computer systems, including special-purpose computer systems.

With reference to FIG. 1, the computer system (100) includes one or more processing cores (110 . . . 11x) and local memory (118) of a central processing unit (“CPU”) or multiple CPUs. The processing core(s) (110 . . . 11x) are, for example, processing cores on a single chip, and execute computer-executable instructions. The number of processing core(s) (110 . . . 11x) depends on implementation and can be, for example, 4 or 8. The local memory (118) may be volatile memory (e.g., registers, cache, RAM), non-volatile memory (e.g., ROM, EEPROM, flash memory, etc.), or some combination of the two, accessible by the respective processing core(s) (110 . . . 11x). Alternatively, the processing cores (110 . . . 11x) can be part of a system-on-a-chip (“SoC”), application-specific integrated circuit (“ASIC”), or other integrated circuit. In FIG. 1, the local memory (118) is on-chip memory such as one or more caches, for which access operations, transfer operations, etc. with the processing core(s) (110 . . . 11x) are fast.

The computer system (100) also includes processing cores (130 . . . 13x) and local memory (138) of a graphics processing unit (“GPU”) or multiple GPUs. The number of processing cores (130 . . . 13x) of the GPU depends on implementation. The processing cores (130 . . . 13x) are, for example, part of single-instruction, multiple data (“SIMD”) units of the GPU. The SIMD width n, which depends on implementation, indicates the number of elements (sometimes called lanes) of a SIMD unit. For example, the number of elements (lanes) of a SIMD unit can be 16, 32, 64, or 128 for an extra-wide SIMD architecture. The GPU memory (138) may be volatile memory (e.g., registers, cache, RAM), non-volatile memory (e.g., ROM, EEPROM, flash memory, etc.), or some combination of the two, accessible by the respective processing cores (130 . . . 13x).

The computer system (100) includes main memory (120), which may be volatile memory (e.g., RAM), non-volatile memory (e.g., ROM, EEPROM, flash memory, etc.), or some combination of the two, accessible by the processing core(s) (110 . . . 11x, 130 . . . 13x). In FIG. 1, the main memory (120) is off-chip memory, for which access operations, transfer operations, etc. with the processing cores (110 . . . 11x, 130 . . . 13x) are slower.

More generally, the term “processor” may refer generically to any device that can process computer-executable instructions and may include a microprocessor, microcontroller, programmable logic device, digital signal processor, and/or other computational device. A processor may be a processing core of a CPU, other general-purpose unit, or GPU. A processor may also be a specific-purpose processor implemented using, for example, an ASIC or a field-programmable gate array (“FPGA”).

The term “control logic” may refer to a controller or, more generally, one or more processors, operable to process computer-executable instructions, determine outcomes, and generate outputs. Depending on implementation, control logic can be implemented by software executable on a CPU, by software controlling special-purpose hardware (e.g., a GPU or other graphics hardware), or by special-purpose hardware (e.g., in an ASIC).

The computer system (100) includes one or more network interface devices (140) such as network interface cards (“NICs”). The network interface device(s) (140) enable communication over a network to another computing entity (e.g., server, other computer system). In some example implementations, the network interface device(s) (140) support wired connections for a network of high-performance computers. In practice, the network may include thousands, tens of thousands, or even more network interface devices. Examples of networks are described below with reference to FIG. 3. Alternatively, the network interface device(s) (140) can support wired connections and/or wireless connections for a wide-area network, local-area network, personal-area network or other network. For example, the network interface device(s) can include one or more Wi-Fi transceivers, an Ethernet port, a cellular transceiver and/or another type of network interface device, along with associated drivers, software, etc.

The network interface device(s) (140) implement logic or software (141) for a reliable transport protocol with fast retransmission of flow packets at the end of a flowlet. For example, one of the network interface device(s) (140) is implemented using an FPGA that provides logic for a reliable transport protocol with fast retransmission of flow packets at the end of a flowlet. Alternatively, one of the network interface device(s) (140) includes memory that stores software implementing aspects of the reliable transport protocol with fast retransmission of flow packets at the end of a flowlet, in the form of firmware or other computer-executable instructions for an FPGA, ASIC, or other processor of the network interface device.

The network interface device(s) (140) convey information such as computer-executable instructions, arbitrary data from an application, or other data in a modulated data signal over network connection(s). A modulated data signal is a signal that has one or more of its characteristics set or changed in such a manner as to encode information in the signal. By way of example, the network connections can use an electrical, optical, RF, or other carrier.

The computer system (100) optionally includes a motion sensor/tracker input (142) for a motion sensor/tracker, which can track the movements of a user and objects around the user. For example, the motion sensor/tracker allows a user (e.g., player of a game) to interact with the computer system (100) through a natural user interface using gestures and spoken commands. The motion sensor/tracker can incorporate gesture recognition, facial recognition and/or voice recognition.

The computer system (100) optionally includes a game controller input (144), which accepts control signals from one or more game controllers, over a wired connection or wireless connection. The control signals can indicate user inputs from one or more directional pads, buttons, triggers and/or one or more joysticks of a game controller. The control signals can also indicate user inputs from a touchpad or touchscreen, gyroscope, accelerometer, angular rate sensor, magnetometer and/or other control or meter of a game controller.

The computer system (100) optionally includes a media player (146) and video source (148). The media player (146) can play DVDs, Blu-ray discs, other disc media and/or other formats of media. The video source (148) can be a camera input that accepts video input in analog or digital form from a video camera, which captures natural video. Or, the video source (148) can be a screen capture module (e.g., a driver of an operating system, or software that interfaces with an operating system) that provides screen capture content as input. Or, the video source (148) can be a graphics engine that provides texture data for graphics in a computer-represented environment. Or, the video source (148) can be a video card, TV tuner card, or other video input that accepts input video in analog or digital form (e.g., from a cable input, HDMI input or other input).

An optional audio source (150) accepts audio input in analog or digital form from a microphone, which captures audio, or other audio input.

The computer system (100) optionally includes a video output (160), which provides video output to a display device. The video output (160) can be an HDMI output or other type of output. An optional audio output (160) provides audio output to one or more speakers.

The storage (170) may be removable or non-removable, and includes magnetic media (such as magnetic disks, magnetic tapes or cassettes), optical disk media and/or any other media which can be used to store information and which can be accessed within the computer system (100).

The computer system (100) may have additional features. For example, the computer system (100) includes one or more other input devices and/or one or more other output devices. The other input device(s) may be a touch input device such as a keyboard, mouse, pen, or trackball, a scanning device, or another device that provides input to the computer system (100). The other output device(s) may be a printer, CD-writer, or another device that provides output from the computer system (100).

An interconnection mechanism (not shown) such as a bus, controller, or network interconnects the components of the computer system (100). Typically, operating system software (not shown) provides an operating environment for other software executing in the computer system (100), and coordinates activities of the components of the computer system (100).

The computer system (100) of FIG. 1 is a physical computer system. A virtual machine can include components organized as shown in FIG. 1.

The term “application” or “program” may refer to software such as any user-mode instructions to provide functionality. The software of the application (or program) can further include instructions for an operating system and/or device drivers. The software can be stored in associated memory. The software may be, for example, firmware. While it is contemplated that an appropriately programmed general-purpose computer or computing device may be used to execute such software, it is also contemplated that hard-wired circuitry or custom hardware (e.g., an ASIC) may be used in place of, or in combination with, software instructions. Thus, examples described herein are not limited to any specific combination of hardware and software.

The term “computer-readable medium” refers to any medium that participates in providing data (e.g., instructions) that may be read by a processor and accessed within a computing environment. A computer-readable medium may take many forms, including non-volatile media and volatile media. Non-volatile media include, for example, optical or magnetic disks and other persistent memory. Volatile media include dynamic random access memory (“DRAM”). Common forms of computer-readable media include, for example, a solid state drive, a flash drive, a hard disk, any other magnetic medium, a CD-ROM, DVD, any other optical medium, RAM, programmable read-only memory (“PROM”), erasable programmable read-only memory (“EPROM”), a USB memory stick, any other memory chip or cartridge, or any other medium from which a computer can read. The term “non-transitory computer-readable media” specifically excludes transitory propagating signals, carrier waves, and wave forms or other intangible or transitory media that may nevertheless be readable by a computer. The term “carrier wave” may refer to an electromagnetic wave modulated in amplitude or frequency to convey a signal.

The innovations can be described in the general context of computer-executable instructions being executed in a computer system on a target real or virtual processor. The computer-executable instructions can include instructions executable on processing cores of a general-purpose processor to provide functionality described herein, instructions executable to control a GPU or special-purpose hardware to provide functionality described herein, instructions executable on processing cores of a GPU to provide functionality described herein, and/or instructions executable on processing cores of a special-purpose processor to provide functionality described herein. In some implementations, computer-executable instructions can be organized in program modules. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and can include any combination of special-purpose hardware and/or hardware with software implementing the functionality described herein.

Numerous examples are described in this disclosure, and are presented for illustrative purposes only. The described examples are not, and are not intended to be, limiting in any sense. The presently disclosed innovations are widely applicable to numerous contexts, as is readily apparent from the disclosure. One of ordinary skill in the art will recognize that the disclosed innovations may be practiced with various modifications and alterations, such as structural, logical, software, and electrical modifications. Although particular features of the disclosed innovations may be described with reference to one or more particular examples, it should be understood that such features are not limited to usage in the one or more particular examples with reference to which they are described, unless expressly specified otherwise. The present disclosure is neither a literal description of all examples nor a listing of features of the invention that must be present in all examples.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” “including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and can include any combination of special-purpose hardware and/or hardware with software implementing the functionality described herein.

Further, the techniques and tools described herein are not limited to the specific examples described herein. Rather, the respective techniques and tools may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps/stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

For the sake of presentation, the detailed description uses terms like “determine” and “select” to describe computer operations in a computer system. These terms denote operations performed by one or more processors or other components in the computer system, and should not be confused with acts performed by a human being. The actual computer operations corresponding to these terms vary depending on implementation.

### II. Example Reliable Transport Protocols.

Innovations described herein relate to a reliable transport protocol. In general, a transport protocol is a set of rules and procedures that govern the exchange of data between computing devices over a computer network. Typically, a sender breaks data such as a message or file into smaller units called packets. The sender sends the packets over the computer network to a receiver, which can recreate the data from information in the packets. As used herein, the terms “sender” and “receiver” indicate roles for transmission and reception, respectively, of packets for a flow. Depending on the transport protocol, the receiver may send feedback (e.g., as acknowledgement packets) to the sender. Also, in many cases, a computing device acts as a sender for one packet flow and as a receiver for a different packet flow.

A transport protocol interoperates with network protocols at other layers. For example, an implementation of a transport layer (transport-layer implementation or transport-layer processing) receives data such as a message or file from an implementation of an application layer, presentation layer, or session layer. The transport-layer processing provides transport-layer packets for the data to an implementation of a network layer such as a variation of Internet Protocol (“IP”). Depending on the transport protocol, transport-layer processing can provide features such as error detection, retransmission of dropped transport-layer packets, control over the rate that transport-layer packets are transmitted (sometimes called flow control), and sequencing of transport-layer packets. Transmission control protocol (“TCP”) and user datagram protocol (“UDP”) are two examples of transport protocols.

A reliable transport protocol uses mechanisms to guarantee, or at least take steps to guarantee, the delivery of transport-layer packets from the sender to the receiver. Such mechanisms can include error detection, retransmission of dropped packets, and flow control. TCP is an example of a reliable transport protocol. The mechanisms that provide for reliable delivery of transport-layer packets can add delay to detect and retransmit dropped packets, which may be significant if many transport-layer packets are dropped. UDP is an example of an unreliable transport protocol. It can provide more timely delivery of transport-layer packets, without the overhead of reliability mechanisms but also without the operations to guarantee delivery.

In some example implementations, transport-layer processing implements a lightweight, reliable, message-based transport protocol. The transport-layer processing adds reliability mechanisms, as described herein, on top of UDP and uses IP routing. Alternatively, innovations described herein can be used in conjunction with another reliable transport protocol.

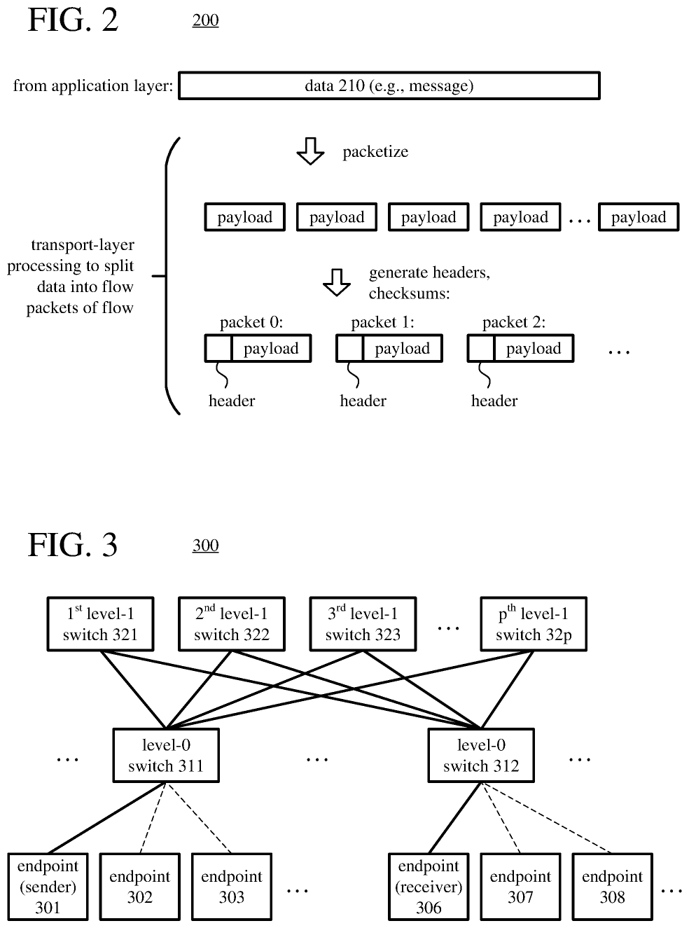

FIG. 2 shows example transport-layer processing (200) in conjunction with which some described embodiments can be implemented. An application-layer entity provides data (210) such as a message or file to a sender for transport-layer processing. In some example implementations, the data (210) is a remote direct memory access (“RDMA”) message, for which data is delivered directly into memory of the receiver upon receipt. An address offset in memory can be included in the payload or header. Alternatively, the data (210) is another type of data.

At the sender, transport-layer processing splits the data (210) into transport-layer flow packets of a flow. In particular, the transport-layer processing packetizes the data (210) into multiple payloads for flow packets of a flow. The payloads can have a uniform size, as shown in FIG. 2, or different sizes. The transport-layer processing generates headers for the respective packets, which are ordered by packet sequence number (“PSN”) in a packet sequence. A given transport-layer packet includes a header followed by one of the payloads. The header can include various fields. Typically, the header includes fields that indicate a source port of the sender, a destination port of the receiver, a PSN, and a length of the header or the entire transport-layer packet, depending on the protocol. One or more flag bits (also called control bits) of the header can indicate the type of the packet or attributes of the packet. Typically, the header also includes a checksum for the transport-layer packet. The checksum can be computed by applying a checksum function (e.g., XOR, one's complement sum, or hash function) to the data subjected to the checksum, which may include the header, the payload, and other header information (e.g., for IP routing). A receiver can use the checksum to detect errors introduced in transmission.

The sender transmits the respective packets of the flow over a network to the receiver. In typical configurations, traffic for the flow is bursty—there can be intensive traffic for the flow over a short period of time, followed by a long period time with no traffic for the flow. To transmit a burst of flow packets for the flow, the sender can transmit the packets, one after another, with the start of a given packet being separated from the start of a next packet by an inter-packet spacing value (also called an inter-packet gap). The inter-packet spacing value need not be exactly the same between all flow packets of the burst but is typically less than the RTT expected for a flow packet. The burst is followed by an idle interval, which is typically longer than a timeout condition for the flow packets.

### III. Example Networks.

FIG. 3 shows an example network (300) in which some described embodiments can be implemented. The example network (300) includes multiple endpoints (301 . . . 308) and multiple network switches (311, 312, 321 . . . 32p). The network switches are hierarchically organized as level-0 switches (311, 312) and level-1 switches (321 . . . 32p). Each of the level-0 switches (311, 312) connects through dedicated links to some of the respective endpoints (301 . . . 308). The dedicated links between the level-0 (311, 312) switches and the endpoints (301 . . . 308) are, for example, high-speed, high-bandwidth wired connections. Each level-0 switch (311, 312) can be connected to 4, 8, 16, or some other number of endpoints. Each level-0 switch (311, 312) also connects through a dedicated link to each level-1 switch (321 . . . 32p). The network (300) can include 8, 16, 32, or some other number of level-1 switches (321 . . . 32p). For example, the first level-0 switch (311) has a first dedicated link to the first level-1 switch (321), a second dedicated link to the second level-1 switch (322), a third dedicated link to the third level-1 switch (323), and so on. The dedicated links between the level-0 (311, 312) switches and the level-1 switches (321 . . . 32p) are, for example, high-speed, high-bandwidth wired connections.

In FIG. 3, one of the endpoints (301) has the role of sender for a packet flow, and another endpoint (306) has the role of receiver for the packet flow. In practice, each of the endpoints (301 . . . 308) can act as both a receiver and a sender through a network interface device at that endpoint.

The example network (300) is used for multi-path delivery of packets. Transport-layer packets of a flow from a given sender, which may be encapsulated as IP packets, travel across any and all of multiple paths through the network (300) to reach a given receiver. For example, transport-layer packets of a flow from the sender at one endpoint (301) travel across p different paths to the receiver at another endpoint (306). The transport-layer packets pass through the first level-0 switch (311), which distributes the transport-layer packets across the p different level-1 switches (321 . . . 32p) for the p different paths, and through the second level-0 switch (312) to reach the receiver at the other endpoint (306). The transport-layer packets can be routed along different paths through the network (300), for example, by adjusting bits of the destination port field in the headers of the respective packet. The header bits for the destination port field in the header of a given packet can control which path is used for the given packet. The header bits for the respective packets can be adjusted according to results from a hash function, so as to cause different packets to “spray” across the different paths. Or, the header bits can be rotated according to a pattern, so as to cause the packets to be routed on different paths according to the pattern. Traffic between any given combination of sender and receiver can be bursty—there can be intensive traffic for a short period of time, followed by a long period of time with no traffic. By delivering transport-layer packets of a flow along multiple paths of the network (300), the available bandwidth of the network (300) can be more consistently and evenly used.

In some example implementations, the paths in the network (300) are symmetric. The paths have the same length in terms of number of hops through the network (300), the same latency, and the same throughput, at least for paths between endpoints connected to different level-0 switches. Alternatively, the paths in the network (300) are asymmetric. That is, the paths through the network (300) can have different lengths in terms of different numbers of hops through the network (300), different latency, and/or different throughput.

Even in a network with symmetric paths used for multi-path delivery, the amount of delay on different paths can vary. A switch may be temporarily busy, causing delay in delivery of packets through that switch. Because of different delays along different paths, packets can be received by a receiver in an order different than the order the packets were sent by a sender. In extreme cases, a packet may be dropped due to congestion at a switch. Rarely, bits of a packet may suffer from bit flips due to interference, an unreliable link, or another cause, resulting in the packet being dropped when loss of information is detected.

In some example implementations, a sender and receiver coordinate to support out-of-order (“OOO”) delivery of transport-layer packets of a flow through the multiple paths of the network (300). In general, for OOO delivery, transport-layer packets can be accepted by a receiver even when those packets are received in an order different than the order the packets were sent by a sender. As described in the next section, an OOO tracking window can be updated to indicate which packets have been received, which permits a delayed packet to be accepted so long as the delayed packet is received within a range defined by the 000 tracking window. Support for OOO delivery can allow for efficient utilization of multiple paths through the network (300), despite different delays on different paths, so as to balance traffic across the multiple paths.

Many of the innovations described herein are adapted for use in conjunction with multi-path delivery of packets over a network. Alternatively, innovations described herein can be used in conjunction with single-path delivery of packets over a network, in which all transport-layer packets of a flow are delivered along a single path between a sender and a receiver.

### IV. Example Reliability Mechanisms for a Transport Protocol.

This section describes various reliability mechanisms that can be used in an implementation of a reliable transport protocol.

For single-path delivery of packets, packets of a flow from a sender to a receiver are delivered over the same path through a network. Typically, the network has multiple potential paths between the sender and receiver, but routing mechanisms cause packets that belong to the same flow to take the same path. Because the flow packets all travel along the same path, the flow packets are assumed to arrive in the same order that the flow packets are sent. Typically, transport-layer processing that supports single-path delivery implements a variant of “Go-Back-N ARQ” protocol (where ARQ stands for automatic repeat request), which can leverage the assumption of in-order arrival to detect packet loss and notify the sender for recovery.

In some implementations of a reliable transport protocol, the receiver sends an acknowledgement (“ACK”) packet when each flow packet from the sender is received. The sender can be implicitly notified about a dropped flow packet through repeated ACKs for the same flow packet. In some reliable transport protocols, an ACK packet indicates the last in-order packet of a flow that has been received by the receiver. For example, suppose the flow packet with PSN 12 is the next flow packet that is expected in order. When the receiver receives a flow packet with PSN 12, the receiver sends an ACK packet (ACK 12) indicating the flow packet with PSN 12 has been received. If the receiver next receives a flow packet with PSN 14, but the flow packet with PSN 13 is the next flow packet that is expected in order, the receiver sends an ACK packet (ACK 12) indicating the flow packet with PSN 12 was the last in-order flow packet received. No representation is made about flow packets with PSNs 14, 15, etc.

When the sender gets the repeated ACK packet (ACK 12), the sender can decide that the flow packet with PSN 13 was dropped. In particular, in some transport protocols, a sender can decide that a given flow packet has been dropped after receiving a threshold count of repeated ACK packets for the given flow packet. The threshold count for repeated ACK packets can be set to a relatively low number (such as 3) for single-path delivery of flow packets, for which in-order delivery is expected. As a fallback retransmission mechanism, a timeout condition can trigger retransmission if the threshold count of repeated ACK packets is never received. After deciding that the flow packet with PSN 13 has been dropped, the sender can react by retransmitting flow packets starting from the flow packet with PSN 13. Unfortunately, subsequent flow packets such as flow packets with PSNs 14, 15, etc. are also retransmitted, even if the receiver correctly received them.

In other implementations of a reliable transport protocol, a receiver sends a negative ACK (“NACK”) packet when the receiver determines that an expected flow packet has been dropped. Thus, the sender can be explicitly notified through a NACK packet when the expected flow packet is not received. For example, when the receiver determines that a flow packet with PSN 13 has been dropped, the receiver sends a NACK packet (NACK 13) indicating the flow packet with PSN 13 has not been received. When it gets the NACK packet (NACK 13), the sender can react by retransmitting the flow packet with PSN 13. Unfortunately, subsequent flow packets such as flow packets with PSNs 14, 15, etc. are also retransmitted, even if the receiver correctly received them.

For several reasons, a Go-Back-N ARQ protocol is ineffective for multi-path delivery in which many flow packets are delivered OOO. First, effective throughput tends to decrease significantly as packet drops increase. Because a receiver enforces in-order delivery through ACK packets or NACK packets, flow packets that are delivered OOO but otherwise received successfully are discarded. Discarding of OOO-delivered flow packets can occur so frequently that goodput (that is, useful throughput excluding retransmission overhead) is significantly reduced. Second, at least for implementations that use ACK packets, when many flow packets are delivered OOO due to differential delay amounts in multi-path delivery, it can be difficult to set a threshold count for repeated ACK packets that triggers retransmission at appropriate times. When the receiver receives an OOO flow packet, the receiver cannot know whether the expected in-order flow packet has been dropped or merely delayed. The sender may receive a large number of repeated ACK packets for an in-order flow packet that is merely delayed, not dropped. Picking a suitable threshold count for repeated ACK packets is further complicated by the sender receiving ACK packets OOO and by occasional bursts of packet delays and/or packet drops (a threshold count that works well during normal operations may be too low when there is burst of packet delays and/or packet drops).

To avoid unnecessary retransmission of duplicate/redundant flow packets that can occur in a Go-Back-N ARQ protocol, transport-layer processing can instead use a variant of selective repeat ARQ (“SR-ARQ”) approach. The receiver can send selective ACK (“SACK”) information along with an ACK packet. Although the ACK packet still indicates the last in-order flow packet received, the SACK information can indicate subsequent flow packets that have been received OOO. In some transport protocols, the SACK information is an n-bit vector (bit mask) with a bit for each of n different flow packets in an OOO tracking window. For example, n is 128 or 256. Larger values of n for the size of the OOO tracking window can significantly increase design area and complexity. For a given flow packet in the OOO tracking window that is associated with a position in the n-bit vector, a first value (such as 0) indicates the given flow packet has not been received, while a second value (such as 1) indicates the given flow packet has been received. Bits of the n-bit vector are updated as flow packets are received OOO. When an in-order flow packet is received, the OOO tracking window slides forward so that the OOO tracking window starts at the next in-order flow packet to be received, whose status is implied to be “not received.”

For example, suppose the flow packet with PSN 18 is the next flow packet that is expected in order. When the receiver receives a flow packet with PSN 19, the receiver sends an ACK packet (ACK 17) indicating the flow packet with PSN 17 was the last in-order flow packet received. SACK information associated with the ACK packet also indicates, however, that the flow packet with PSN 19 was successfully received. When the receiver receives a flow packet with PSN 20, the receiver sends another ACK packet (ACK 17) with updated SACK information. The ACK packet (ACK 17) still indicates the flow packet with PSN 17 was the last in-order flow packet received, but the SACK information now indicates that the flow packet with PSN 20 was successfully received.

By using SACK information, a limited number of flow packets can be received OOO. This can improve performance in terms of goodput even for single-path delivery—if flow packets are delivered OOO but within the OOO tracking window, only dropped flow packets are retransmitted. Delayed packets that are delivered OOO need not be retransmitted. In terms of delay for single-path delivery, a sender can retransmit a dropped flow packet after a timeout condition is satisfied for the flow packet. Or, in some transport protocols, a sender can more quickly decide that a given flow packet has been dropped after receiving a threshold count of repeated ACK packets for the given flow packet. The threshold count for repeated ACK packets can be set to a relatively low number (such as 3) for single-path delivery, for which in-order delivery is expected for flow packets and for ACK packets.

Previous implementations of SR-ARQ approaches tend to be ineffective for multi-path delivery in which many flow packets are delivered OOO. When many flow packets are delivered OOO, it can be difficult to set a threshold count for repeated ACK packets that triggers retransmission at appropriate times, as noted above.

In addition, retransmission mechanisms for Go-Back-N ARQ approaches and SR-ARQ approaches are not effective for flow packets at the end of a flowlet. In general, a flowlet is a burst of packets from the same flow, followed by an idle interval. Whether flow packets are delivered using single-path delivery or multi-path delivery, the retransmission mechanisms are too slow, or do not work at all, for flow packets at the end of a flowlet.

In some approaches to retransmission of dropped packets, a timeout condition can be evaluated to determine whether to retransmit a flow packet. If an ACK packet is not received for the next in-order flow packet before a timeout timer expires, the sender retransmits the next in-order flow packet. In general, timeout-based retransmission mechanisms tend to be slow to respond to packet drops, whether flow packets are delivered using single-path delivery or multi-path delivery. Although the duration of the timer for a timeout condition depends on implementation, the duration is often orders of magnitude higher than a typical round trip time for a packet, so as to provide time for packets to be delivered OOO and acknowledged without retransmission. For a flow packet at the end of a flowlet, delay due to the timeout condition may be especially significant after other flow packets of the flowlet have been delivered, since the delay is not masked by concurrent delivery of other flow packets. In some implementations, timeout-based retransmission mechanisms operate at the scale of hundreds of microseconds or milliseconds, which can significantly delay completion time for a packet flow if one of the last packets of the flowlet is dropped. In some cases, a long timeout timer may even lead to more frequent instances of a sender stalling because an OOO tracking window cannot slide forward in time.

Other retransmission mechanisms use a count of repeated ACK packets or other threshold for retransmission. If a flow packet at the end of a flowlet is dropped, the threshold for retransmission cannot be satisfied, since there are no later “in-flight” flow packets to trigger ACK packets or other feedback from the receiver, at least before the timeout condition is satisfied. (There may be later flow packets in the same flow, after the idle interval following the flowlet, but the later flow packets are not soon enough to cause the receiver to provide useful feedback for the flow packet at the end of the flowlet.) For example, in single-path delivery, if the last flow packet of a flowlet is dropped, there is no timely ACK packet to signal that the next in-order flow packet (here, the last flow packet) was not received. In multi-path OOO delivery of flow packets, an OOO tracking window can track multiple flow packets at the end of a flowlet. When there are not enough later flow packets “in flight” to provide timely sufficient feedback to satisfy the threshold for retransmission, retransmission of the multiple flow packets at the end of the flowlet will not be triggered until the timeout condition is satisfied.

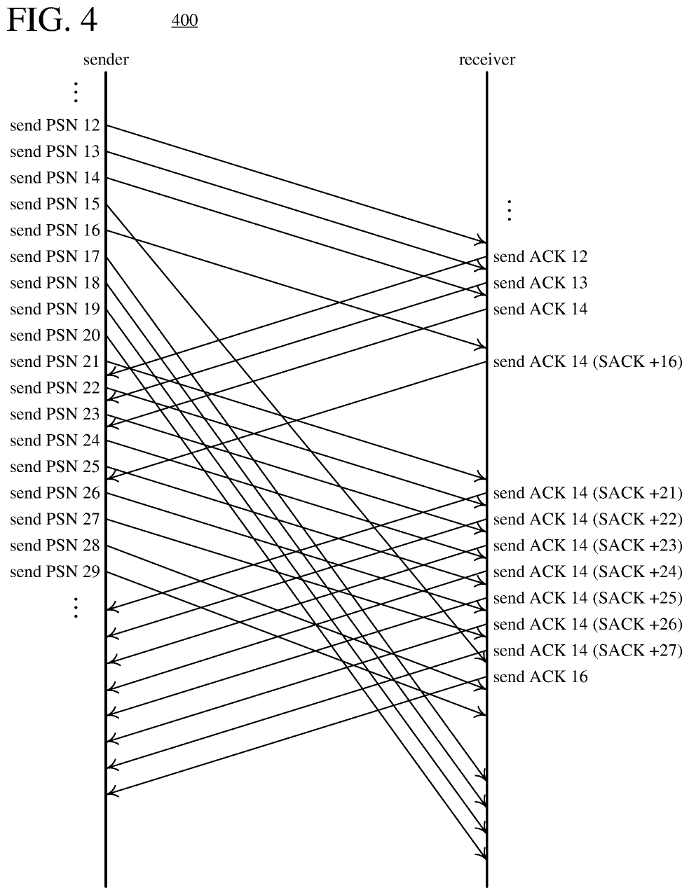

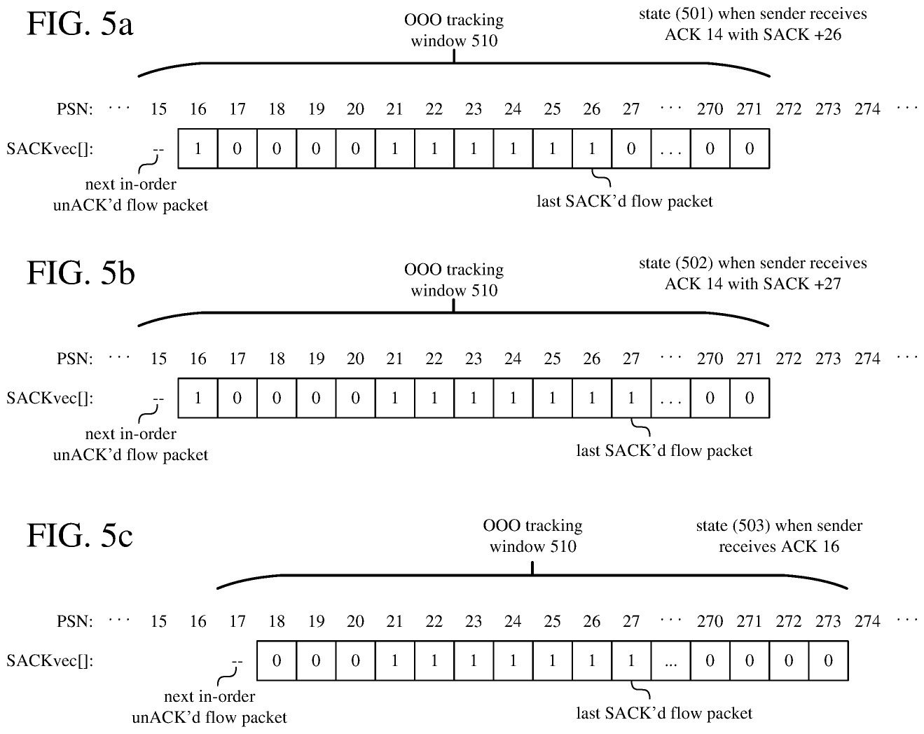

FIG. 4 shows delivery of packets of an example packet sequence (400) over multiple paths of a network with multi-path delivery. FIGS. 5a to 5c show states (501, 502, 503) of an example OOO tracking window (510) at three different times for the example packet sequence (400).

With reference to FIG. 4, the sender sends transport-layer packets of a flow in a packet sequence (400) over multiple paths of network to a receiver. FIG. 4 shows transmission of flow packets from a packet with PSN 12 to a packet with PSN 29. Transmission of other flow packets is not shown. The flow packets with PSNs 12 to 14 are delivered promptly, and the receiver sends ACK packets (ACK 12, ACK 13, ACK 14) for the respective flow packets after they are received. The sender also sends the flow packets with PSNs 15 and 16, but the flow packet with PSN 15 is delayed. When the receiver receives the flow packet with PSN 16, the receiver sends an ACK packet (ACK 14), which indicates the flow packet with PSN 14 was the last in-order flow packet received. The ACK packet includes SACK information that indicates the flow packet with PSN 16 has been received.

The sender sends the flow packets with PSNs 17 to 29, but the flow packets with PSNs 17 to 20 are significantly delayed. When the receiver receives the flow packet with PSN 21, the receiver sends an ACK packet (ACK 14), which indicates the flow packet with PSN 14 is still the last in-order flow packet received, along with SACK information that indicates the flow packet with PSN 21 has been received. The receiver similarly sends ACK packets (ACK 14) and updated SACK information when the flow packets with PSNs 22 to 27 are received.

FIG. 5a shows the state (501) of an OOO tracking window (510) at the sender after the sender has received the ACK packet (ACK 14) and SACK information indicating the flow packet with PSN 26 was received. The OOO tracking window (510) starts after the last in-order flow packet that was received, which was the flow packet with PSN 14. The status of the next in-order flow packet, which is the flow packet with PSN 15, is implied to be “not received” by the start of the OOO tracking window (510). After that, the OOO tracking window (510) has indicator bits updated to match a 256-bit SACK vector SACKvec[ ], which includes an indicator bit for each of the next 256 flow packets in the packet sequence. For the SACK vector, SACKvec[i] is the indicator bit for the flow packet with PSN equal to next_in_order_PSN+i+1, where next_in_order_PSN is the PSN of the next in-order flow packet to be received, for i between 0 and 255 inclusive. In the state (501) shown in FIG. 5a, based on the SACK information in previously received ACK packets, the status is “received” (shown as 1 for the respective indicator bits) for the flow packets with PSN 16 and PSNs 21 to 26, which have been acknowledged as received. The last selectively acknowledged flow packet is the flow packet with PSN 26. The status is still “not received” (shown as 0 for the respective indicator bits) for the remaining flow packets in the OOO tracking window (510), including the delayed flow packets with PSNs 17 to 20.

FIG. 5b shows the state (502) of the OOO tracking window (510) at the sender after the sender has received the ACK packet (ACK 14) and SACK information indicating the flow packet with PSN 27 was received. The OOO tracking window (510) has not moved forward in time. The OOO tracking window (510) still starts after the last in-order flow packet that was received, which was the flow packet with PSN 14. The status of the next in-order flow packet, which is the flow packet with PSN 15, is still implied to be “not received.” In the SACK vector, the status for the flow packet with PSN 27 is now “received” (shown as 1 for the indicator bit). The last selectively acknowledged flow packet is the flow packet with PSN 27. Otherwise, the indicator bits of the OOO tracking window (510), which match the SACK vector, are unchanged.

FIG. 5c shows the state (503) of the OOO tracking window (510) at the sender after the sender has received the ACK packet (ACK 16), which indicates the delayed flow packet with PSN 15 has been received. Since the flow packet with PSN 16 has already been acknowledged as received, the OOO tracking window (510) slides forward two positions. The OOO tracking window (510) starts after the last in-order flow packet that was received, which is now the flow packet with PSN 16. The status of the next in-order flow packet, which is the flow packet with PSN 17, is implied to be “not received” by the start of the OOO tracking window (510). The indicator bits from the SACK vector for the flow packets from PSNs 18 to 271 are shifted to the new start of the OOO tracking window (510) but otherwise unchanged. After them, the OOO tracking window (510) and SACK vector include an indicator bit for each new flow packet in the OOO tracking window (510). Indicator bits at positions for the flow packets with PSN 272 and PSN 273 indicate the status of those flow packets is “not received” (shown as 0 for the respective indicator bits).

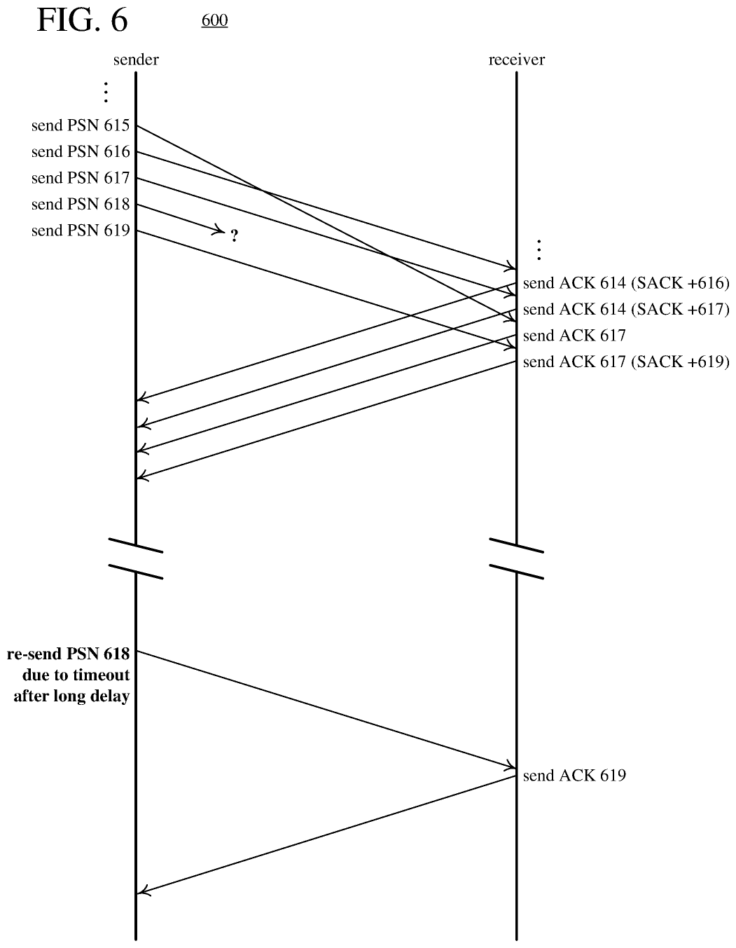

FIG. 6 shows delivery of packets of an example packet sequence (600) over multiple paths of a network according to a reliable OOO transport protocol with delayed retransmission at the end of a packet flowlet. The sender sends transport-layer packets of a flowlet in a packet sequence (600) over multiple paths of a network to a receiver. FIG. 6 shows transmission of flow packets from a flow packet with PSN 615 to a flow packet with PSN 619, which is the last flow packet of the flowlet. Transmission of earlier flow packets is not shown.

With reference to FIG. 6, the flow packets with PSNs 615 to 617 are delivered, although the flow packet with PSN 615 is slightly delayed. When the receiver receives the flow packet with PSN 616, the receiver sends an ACK packet (ACK 614), which indicates the flow packet with PSN 614 was the last in-order flow packet received. The ACK packet includes SACK information that indicates the flow packet with PSN 616 has been received. The receiver similarly sends an ACK packet (ACK 614) and updated SACK information after the receiver receives the flow packet with PSN 617. When the receiver receives the flow packet with PSN 615, the receiver sends an ACK packet (ACK 617), which indicates the flow packet with PSN 617 was the last in-order flow packet received.

The flow packet with PSN 618 is significantly delayed, and potentially lost. When the receiver receives the flow packet with PSN 619, the receiver sends an ACK packet (ACK 617), which indicates the flow packet with PSN 617 was the last in-order flow packet received. The ACK packet includes SACK information that indicates the flow packet with PSN 619 has been received.

Although the sender implements a fast retransmission mechanism that uses feedback from the receiver, the sender receives insufficient feedback to trigger fast retransmission for the flow packet with PSN 618. For example, suppose a threshold for fast transmission is three repeated ACK packets for the same flow packet. In the example of FIG. 6, the sender receives two repeated ACK packets for the flow packet with PSN 617, which is not enough to trigger the threshold for fast transmission. More generally, in this situation, for any threshold for fast retransmission, the sender receives insufficient feedback from ACK packets and SACK information to trigger fast retransmission. There are not enough flow packets “in flight” after the flow packet with PSN 618 to provide sufficient feedback in a timely manner to satisfy the threshold for retransmission.

Instead, the sender relies on a timeout-based retransmission mechanism. When the timeout condition is satisfied, the sender retransmits the flow packet with PSN 618. When the receiver receives the flow packet with PSN 618, the receiver sends an ACK packet (ACK 619), which indicates the flow packet with PSN 619 was the last in-order flow packet received. Although the timeout-based retransmission mechanism works to complete delivery of the packet flowlet, the timeout-based retransmission mechanism is slow to respond to the loss of the flow packet with PSN 618. The delay is especially significant all other flow packets of the flowlet have been delivered for a while—the delay is not masked by concurrent delivery of other flow packets.

V. Reliable Transport Protocols with Fast Retransmission of Packets at the End of a Flowlet.

Fast retransmission mechanisms typically use feedback metadata such as acknowledgement (“ACK”) metadata and selective ACK (“SACK”) metadata from a receiver when deciding whether to trigger fast retransmission. If sufficient feedback is not received in a timely manner, e.g., because a packet at the end of a flowlet is dropped and there are few if any flow packets “in flight” after the dropped packet, such fast retransmission mechanisms are not effective. Timeout-based retransmission mechanisms can detect a dropped packet at the end of a packet flowlet, but they add significant delay.

This section describes innovations in operations of a reliable transport protocol with fast retransmission of packets at the end of a flowlet. In general, a flowlet is a burst of multiple transport-layer flow packets from a given packet flow, followed by an idle interval. For example, the burst of flow packets is a set of flow packets for the same data such as a message or file, where the packets are at least approximately separated in transmission by an inter-packet spacing value, and where the idle interval is longer than a timeout condition for the reliable transport protocol. The fast retransmission mechanisms can be implemented in sender logic for the reliable transport protocol. According to the fast retransmission mechanisms, a sender monitors sender-side state that tracks delivery status of flow packets of a flow. The sender-side state indicates which flow packets have not been acknowledged as received. When the end of a packet flowlet is reached, the sender selectively performs quick retransmission operations to preemptively address a situation in which a flow packet toward the end of the packet flowlet has been dropped or significantly delayed.

For single-path delivery, a flow packet toward the end of the flowlet can be the last flow packet of the flow or a flow packet close to the end of the flowlet (e.g., within three or four flow packets from the end of the packet flowlet). For multi-path delivery, the range of vulnerability for unacknowledged flow packets towards the end of the flowlet is much larger-more flow packets potentially have insufficient feedback metadata to trigger fast retransmission in a timely manner. For multi-path delivery, a flow packet toward the end of the flowlet can be any flow packet in a much larger range. In some example implementations, when an OOO tracking window tracks delivery status of n flow packets that are delivered with multi-path delivery over a network, a flow packet toward the end of the flowlet can be any of the final n flow packets of the flowlet.

This section describes several alternative approaches for the quick retransmission operations. Any of the approaches can help the sender quickly react to packet drops (and delays) towards the end of a flowlet. The approaches can be applied in conjunction with single-path delivery or multi-path delivery. In particular, for network scenarios with multi-path delivery in which fast retransmission mechanisms are otherwise ineffective, many of the approaches described herein effectively address erratically delayed or dropped packets at the end of a flowlet (“stragglers”) and reduce high latencies for packets at the end of a flowlet (“high tail latencies”).

### A. Selectively Repeating Last Flow Packets at the End of a Packet Flowlet.

According to one approach for quick retransmission operations at the end of a packet flowlet, a sender selectively but quickly resends unacknowledged flow packets at the end of the packet flowlet. The sender determines which flow packets have not yet been acknowledged. Based on various criteria (such as workload at the sender), the sender selectively resends one or more unacknowledged flow packets of the flowlet. After the fast retransmission, if a flow packet toward the end of the flowlet is dropped or significantly delayed, in many cases the sender has already retransmitted the flow packet that was dropped or delayed. In any event, preemptively resending unacknowledged flow packets after the end of the flowlet can help trigger another fast retransmission mechanism, instead of relying on a timeout condition to cause retransmission of a dropped packet at the end of the flowlet. The sender can continue to selectively resend unacknowledged flow packets of the flowlet until delivery of the flowlet is completed.

In some example implementations, a sender monitors “in-flight” packets in an OOO tracking window. The OOO tracking window tracks delivery status of a span of n flow packets of a flowlet. To address a potential lack of feedback metadata for the last n flow packets of the flowlet, the sender sends up to n additional packets that repeat the last n flow packets of the flowlet, or at least those of the flow packets that have not been acknowledged yet. In other words, the last n flow packets of the flowlet are followed by up to n flow packets that repeat those of the last n flow packets that have not been acknowledged yet. The additional flow packets cause the receiver to provide additional feedback metadata. In case any of the n flow packets of the flowlet has been dropped or significantly delayed and none of the repeated flow packets replaces the dropped/delayed flow packet of the flowlet, the sender can use the additional feedback metadata to identify the dropped/delated flow packet and resend the flow packet.

In some example implementations, the sender resends unacknowledged flow packets opportunistically. In particular, the sender selectively resends unacknowledged flow packets depending on activity level of the sender. For example, the sender monitors whether it has other flow packets in the same flow to send to the receiver. If the sender does not have new flow packets in the same flow to send to the receiver, or if the amount of new flow packets in the same flow is below a threshold, the sender resends unacknowledged flow packets of the flowlet. On the other hand, if the sender has new flow packets in the same flow to send to the receiver, and the new flow packets are already expected to trigger feedback metadata in a timely manner, the sender skips the preemptive resending of unacknowledged flow packets at the end of the flowlet.

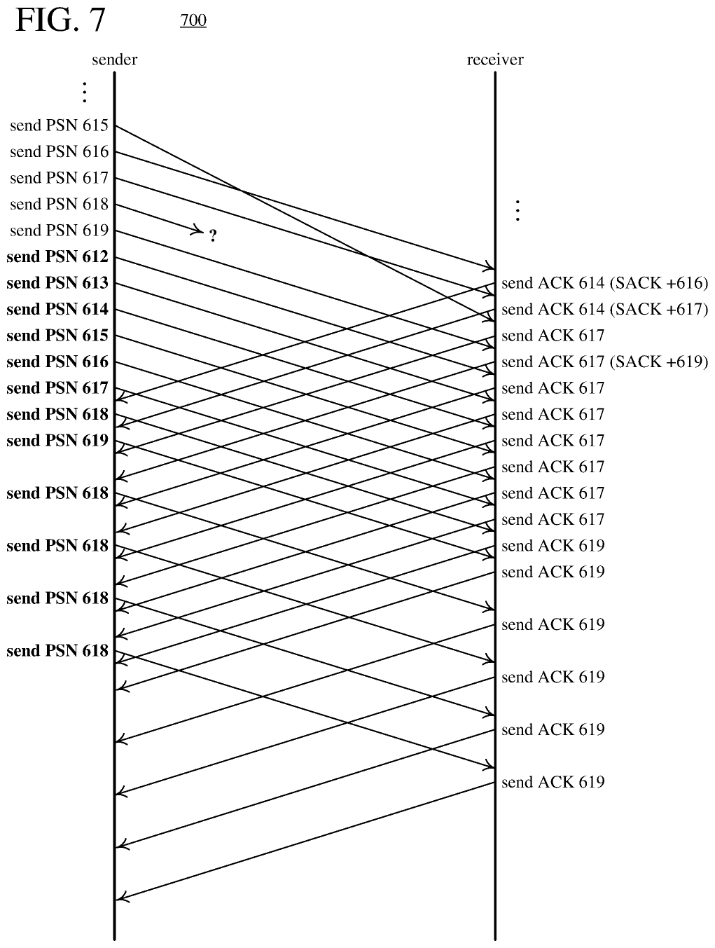

FIG. 7 shows delivery of packets of an example packet sequence (700) over a network according to a reliable transport protocol with selective quick retransmission of packets at the end of a packet flowlet. The sender sends transport-layer packets of a flowlet in a packet sequence (700) over multiple paths of a network to a receiver. Like FIG. 6, FIG. 7 shows transmission of flow packets from a flow packet with PSN 615 to a flow packet with PSN 619, which is the last flow packet of the flowlet. Transmission of earlier flow packets is not shown. The flow packets with PSNs 615 to 617 and 619 are delivered and acknowledged as described with reference to FIG. 6. The flow packet with PSN 618 is significantly delayed, and potentially lost.

In the example of FIG. 7, after sending the flow packet with PSN 619, the sender starts to resend unacknowledged flow packets of the flowlet. The last in-order flow packet to be acknowledged is the flow packet with PSN 611. As such, the sender resends the flow packets with PSNs 612 to 619. For each of the repeated flow packets with PSNs 612 to 617, after the receiver receives the flow packet, the receiver sends an ACK packet (ACK 617) in response. After the receiver receives the repeated flow packet with PSN 618, which was previously dropped or delayed, the receiver sends an ACK packet (ACK 619) in response. The ACK packet (ACK 619) indicates the last in-order flow packet received was the flow packet with PSN 619, which was previously received and acknowledged with SACK information. When the sender receives the ACK packet (ACK 619), the sender determines the packet flowlet is complete. Before that point, however, the sender continues to resend the unacknowledged flow packet with PSN 618, which the receiver acknowledges.

### B. Sending Flush Packets at the End of a Packet Flowlet.

According to another approach for quick retransmission operations at the end of a packet flowlet, a sender sends flush packets after the last flow packet of the packet flowlet. Flush packets are examples of end-of-flowlet (“EOF”) packets. The flush packets cause a receiver to provide feedback metadata about flow packets at the end of the flowlet. Without the flush packets, the receiver might not provide such feedback metadata in a timely manner. Based on the feedback metadata, the sender selectively resends unacknowledged flow packets at the end of the flowlet. If a flow packet toward the end of the flowlet has been dropped, feedback metadata responsive to the flush packets can trigger retransmission much faster than a timeout condition would have triggered retransmission. The sender can continue to send flush packets and selectively resend unacknowledged flow packets of the flowlet until delivery of the packet flowlet is completed.

In some example implementations, a sender monitors “in-flight” packets in an OOO tracking window, which can track delivery status of n flow packets of a flowlet. To address a potential lack of feedback metadata for the last n flow packets of the flowlet, the sender sends n flush packets. In other words, the last n flow packets of the flowlet are followed by n flush packets, which cause the receiver to provide additional feedback metadata. If any of the last n flow packets of the flowlet has been dropped or significantly delayed, the sender can use the feedback metadata to identify the dropped/delayed flow packet and resend the flow packet.

In some example implementations, a sender sends flush packets opportunistically. In particular, the sender selectively sends flush packets depending on activity level of the sender. For example, the sender monitors whether it has other flow packets in the same flow to send to the receiver. If the sender does not have new flow packets in the same flow to send to the receiver, or if the amount of new flow packets in the same flow is below a threshold, the sender sends flush packets. On the other hand, if the sender has new flow packets in the same flow to send to the receiver, and the new flow packets are already expected to trigger feedback metadata in a timely manner, the sender skips the sending of flush packets at the end of the flowlet.

In some example implementations, a flush packet has a payload that is empty or has a nominal (small) size. The flush packets do not significantly contribute to network congestion, and the flush packets can be processed without memory read operations to get contents of the payloads.

Alternatively, the payload of a flush packet can be the payload of an unacknowledged flow packet of the flowlet, in which case delivery of the flush packet can provide the unacknowledged flow packet of the flowlet. (In this variation, the flush packet is similar to a retransmitted flow packet, as described in section V.A, although the convention followed for PSN numbering may be different.)

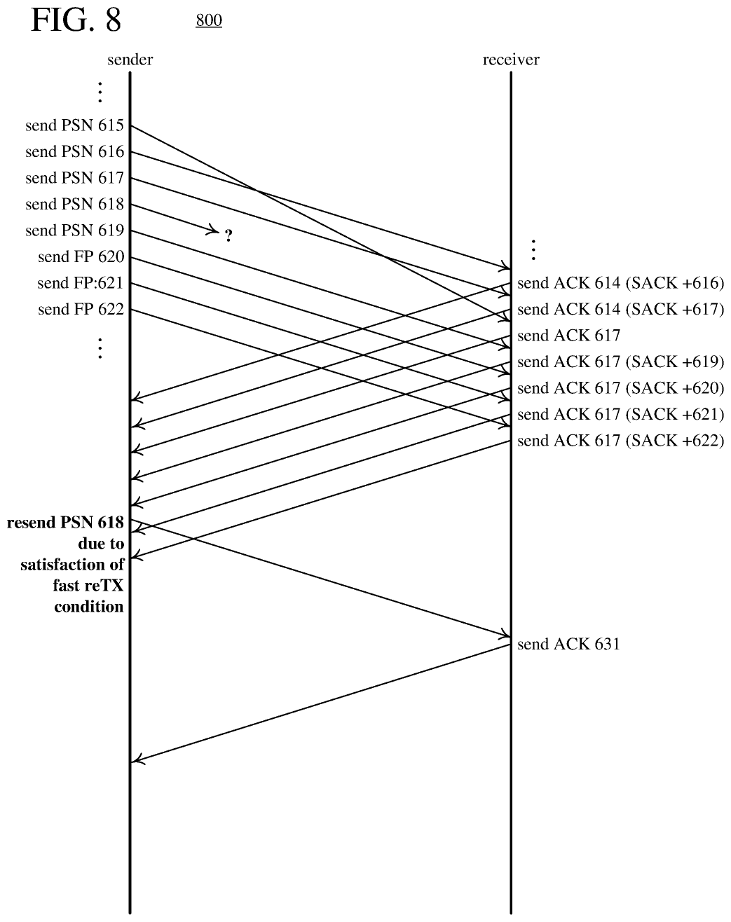

FIG. 8 shows delivery of packets of an example packet sequence (800) over a network according to a reliable transport protocol that uses flush packets at the end of a packet flowlet. The sender sends transport-layer packets of a flowlet in a packet sequence (800) over multiple paths of a network to a receiver. Like FIG. 6, FIG. 8 shows transmission of flow packets with PSNs 615 to 619, which is the last flow packet of the flowlet. Transmission of earlier flow packets is not shown. The flow packets with PSNs 615 to 617 and 619 are delivered and acknowledged as described with reference to FIG. 6. The flow packet with PSN 618 is significantly delayed, and potentially lost.

In the example of FIG. 8, after sending the flow packet with PSN 619, the sender starts to send flush packets. The flush packets have PSNs that follow the last flow packet of the flowlet in the packet sequence. In FIG. 8, the sender sends flush packets with PSNs 620, 621, 622, and so on. For each of the flush packets, after the receiver receives the flush packet, the receiver sends an ACK packet (ACK 617) in response. The ACK packet includes updated SACK information, which indicates the flush packet has been received.

The sender receives the feedback metadata for the flush packets. In particular, the sender receives the ACK packets (ACK 617) sent in response to the flush packets. The sender uses the feedback metadata to update its tracking window and determine whether a fast retransmission condition is satisfied. Eventually, the sender determines that a fast retransmission condition is satisfied (e.g., that a count of repeated ACK packets is greater than a threshold; or that a special retransmission condition for EOF situations is satisfied, which immediately resends any unacknowledged flow packet of the flowlet). The sender resends the flow packet with PSN 618. After the receiver receives the repeated flow packet with PSN 618, which was previously dropped or delayed, the receiver sends an ACK packet (ACK 631) in response. The ACK packet (ACK 631) indicates the last in-order packet received was the flush packet with PSN 631, which was previously received and acknowledged with SACK information. When the sender receives the ACK packet (ACK 631), the sender determines the packet flowlet is complete. Before that point, however, the sender can continue to resend the unacknowledged flow packet with PSN 618 (not shown).

### C. Sending Query Packets at the End of a Packet Flowlet.

According to another approach for fast retransmission operations at the end of a packet flowlet, a sender sends one or more query packets after the last flow packet of the packet flowlet. Query packets are examples of EOF packets. The query packet(s) cause a receiver to provide feedback metadata about flow packets at the end of the flowlet. Without the query packet(s), the receiver might not provide such feedback metadata in a timely manner. Based on the feedback metadata, the sender selectively resends unacknowledged flow packets at the end of the flowlet. If a flow packet toward the end of the flowlet is dropped, feedback metadata responsive to the query packet(s) can trigger retransmission much faster than a timeout condition would have triggered retransmission. The sender can continue to send query packets and selectively resend unacknowledged flow packets of the flowlet until delivery of the packet flowlet is completed.

In some example implementations, a sender monitors “in-flight” packets in an OOO tracking window, which can track delivery status of n flow packets of a flowlet. To address a potential lack of feedback metadata for the last n flow packets of the flowlet, the sender sends one or more query packets. The query packet(s) cause the receiver to provide additional feedback metadata. If any of the last n flow packets of the flowlet has been dropped or significantly delayed, the sender can use the feedback metadata to identify the dropped/delayed flow packet and resend the flow packet.

In some example implementations, a sender sends query packets opportunistically. In particular, the sender selectively sends query packets depending on activity level of the sender. For example, the sender monitors whether it has other flow packets in the same flow to send to the receiver. If the sender does not have new flow packets in the same flow to send to the receiver, or if the amount of new flow packets in the same flow is below a threshold, the sender starts to send query packets. On the other hand, if the sender has new flow packets in the same flow to send to the receiver, and the new flow packets are already expected to trigger feedback metadata in a timely manner, the sender skips the sending of query packets at the end of the flowlet.

In some example implementations, a query packet has a payload that is empty or has a nominal (small) size. The query packets do not significantly contribute to network congestion, and the query packets can be processed without memory read operations to get contents of the payloads. One or more bits of the header of a query packet can mark the query packet as a special type (or class) of packet, which causes the receiver to report its packet delivery state with SACK information.

Alternatively, the payload of a query packet can be the payload of an unacknowledged flow packet of the flowlet, in which case delivery of the query packet can provide the unacknowledged flow packet of the flowlet. (In this variation, the query packet is similar to a retransmitted flow packet, as described in section V.A, although one or more bits of the header of a query packet can still mark the query packet as a special type (or class) of packet, which causes the receiver to report its packet delivery state with SACK information.

In some example implementations, the sender periodically sends query packets according to a query interval. For example, the query interval is half the expected round trip time (“RTT”) for flow packets. Alternatively, the query interval has a different value such as the RTT expected for flow packets or a value based on delay skew between fastest and slowest paths of the network.

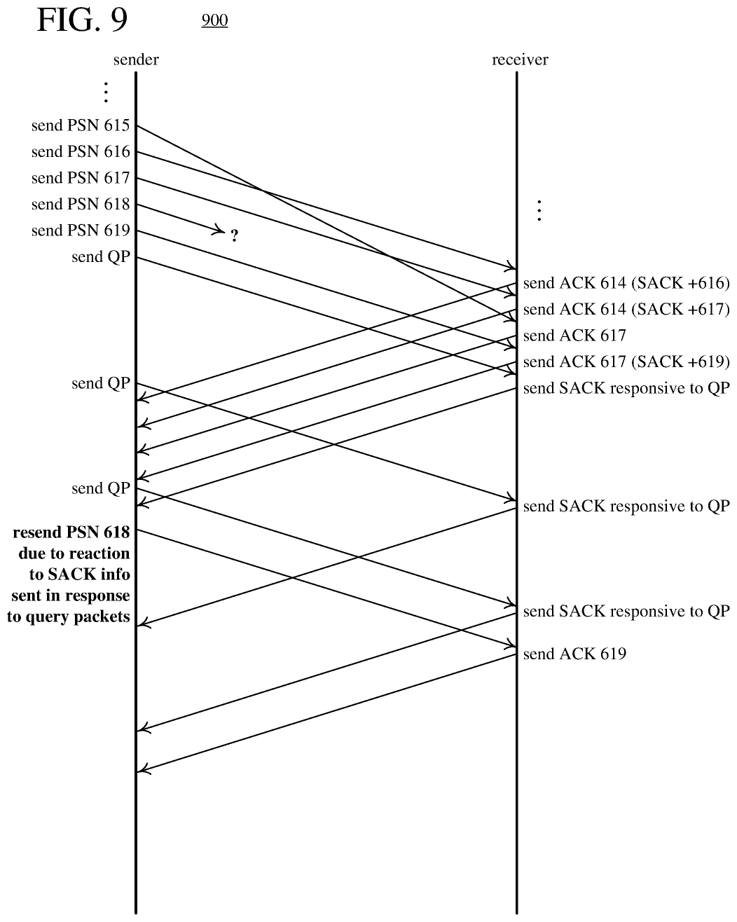

FIG. 9 shows delivery of packets of an example packet sequence (900) over a network according to a reliable transport protocol that uses query packets at the end of a packet flowlet. The sender sends transport-layer packets of a flowlet in a packet sequence (900) over multiple paths of a network to a receiver. Like FIG. 6, FIG. 9 shows transmission of flow packets with PSNs 615 to 619, which is the last flow packet of the flowlet. Transmission of earlier flow packets is not shown. The flow packets with PSNs 615 to 617 and 619 are delivered and acknowledged as described with reference to FIG. 6. The flow packet with PSN 618 is significantly delayed, and potentially lost.

In the example of FIG. 9, after sending the flow packet with PSN 619, the sender starts to send query packets. In some example implementations, the query packets do not have PSNs. In FIG. 9, the sender periodically sends query packets according to a query interval. For each of the query packets, after the receiver receives the query packet, the receiver sends updated SACK information (potentially in an ACK packet) in response, which indicates the query packet has been received and may include feedback information for flow packets of the flowlet.

The sender receives the feedback metadata for the query packets. In particular, the sender receives the updated SACK information sent in response to the query packets. The sender uses the feedback metadata to update its tracking window and identify flow packets of the flowlet that have not been acknowledged. Eventually, the sender determines that a fast retransmission condition is satisfied (e.g., that a special retransmission condition for EOF situations is satisfied, which immediately resends any unacknowledged flow packet of the flowlet). The sender resends the flow packet with PSN 618. After the receiver receives the repeated flow packet with PSN 618, which was previously dropped or delayed, the receiver sends an ACK packet (ACK 619) in response. The ACK packet (ACK 619) indicates the last in-order packet received was the flow packet with PSN 619, which was previously received and acknowledged with SACK information. When the sender receives the ACK packet (ACK 619), the sender determines the packet flowlet is complete. Before that point, however, the sender can continue to periodically send query packets and/or resend the unacknowledged flow packet with PSN 618 (not shown).

Alternatively, query packets can have PSNs that follow the last flow packet of the flowlet in the packet sequence. In this variation, the query packets are in effect similar to flush packets, as described in section V.B.

### D. Example Techniques for Selective Fast Retransmission of Packets at the End of a Packet Flowlet.

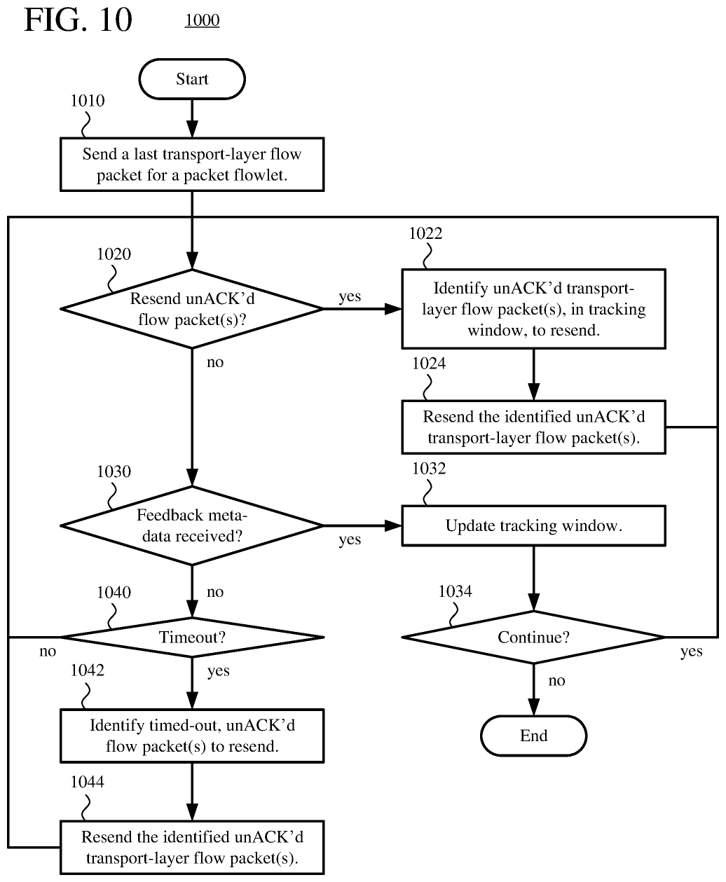

FIG. 10 shows a generalized technique (1000) for delivery of packets according to a reliable transport protocol with selective fast retransmission of packets at the end of a packet flowlet. A network interface device, as described with reference to FIG. 1 or otherwise, can perform the technique (1000). The technique (1000) shows operations from the perspective of a sender, which manages delivery of a packet flow according to a reliable transport protocol.

With reference to FIG. 10, the sender sends (1010), to a receiver across a network, a last transport-layer flow packet among multiple transport-layer flow packets for a flowlet. In general, the flowlet is a burst of multiple flow packets, followed by an idle interval. In some example implementations, the flow packets are delivered on multiple paths of the network using multi-path delivery. The multiple paths of the network can be symmetric, in which case the multiple paths have identical length (in terms of the number of multiple hops between endpoints through network switches). Or, the multiple paths of the network can be asymmetric. Alternatively, the flow packets are delivered on a single path of the network using single-path delivery.

The sender then performs operations in a main processing loop. For example, in the main processing loop, the sender can selectively resend flow packets of the flowlet to the receiver, react to feedback metadata from the receiver, and react to timeout events.

After sending the last flow packet of the flowlet but before satisfaction of a timeout condition for the last flow packet, the sender selectively resends one or more of the sent flow packets of the flowlet that have not yet been acknowledged as received according to a tracking window. In FIG. 10, the sender checks (1020) whether to resend unacknowledged flow packets. For example, the sender determines a metric that quantifies activity level. The metric can depend on the amount of data ready to send at the sender to the receiver for the given packet flow and/or depend on another factor. The sender compares the metric to a threshold. If the metric satisfies the threshold, the sender resends one or more unacknowledged flow packets of the flowlet. Otherwise (the metric does not satisfy the threshold), the sender skips resending unacknowledged flow packets of the flowlet. In this way, the sender can skip resending unacknowledged flow packets of the flowlet if the network is already busy or likely to be busy, or if the sender will soon send flow packets to the receiver that should trigger feedback metadata.

To resend unacknowledged flow packets, the sender identifies (1022), in the tracking window, one or more of the sent flow packets of the flowlet that have not yet been acknowledged as received. The unacknowledged flow packet(s) are indicated as not received in the tracking window. For example, the sender identifies every unacknowledged flow packet of the flowlet according to the updated tracking window, identifies an oldest unacknowledged flow packet of the flowlet in the updated tracking window, or identifies unacknowledged flow packets of the flowlet according to another strategy. The sender resends (1024) the identified unacknowledged flow packet(s) of the flowlet to the receiver across the network. The sender then continues the main processing loop.

The sender can start resending unacknowledged flow packets of the flowlet right after sending the last flow packet of the flowlet. Depending on implementation, the sender can start resending unacknowledged flow packets of the flowlet less than a target time after sending the last flow packet of the flowlet. For example, the target time is a time less than a round trip time expected for the flow packets. Alternatively, the target time is defined in some other way. By quickly resending one or more of the sent flow packets of the flowlet that have not yet been acknowledged as received, the sender can more quickly fill any holes in the tracking window.

In the main processing loop, the sender also checks (1030) whether any feedback metadata has been received from the receiver. For example, the feedback metadata is received as one or more ACK packets. The feedback metadata can include ACK metadata and SACK metadata. For a given flow packet, the ACK metadata can indicate receipt, by the receiver, of the given flow packet, and the SACK metadata can indicate receipt, by the receiver, of any of the sent flow packets that is after the given flow packet in a packet sequence.

If the sender has received feedback metadata, the sender updates (1032) a tracking window based at least in part on the feedback metadata. When the flow packets are delivered using multi-path delivery, the tracking window is an OOO tracking window that tracks n packets, where n is greater than 1. ACK metadata can indicate the start of an updated OOO tracking window. Based on ACK metadata, the sender can move the OOO tracking window forward in time. SACK metadata can indicate which flow packets in the OOO tracking window have been received. Based on SACK metadata, the sender can update the OOO tracking window to indicate OOO receipt of flow packets.

Based on the feedback metadata and updated tracking window, the sender can check (1034) whether to continue operations for the packet flowlet. If all flow packets of the flowlet have been acknowledged as received, the sender can stop operations for the packet flowlet. Otherwise, the sender continues the main processing loop.

Subsequently, the sender can selectively resend, to the receiver across the network, one or more unacknowledged flow packets of the flowlet according to the updated tracking window, as explained above with reference to the selective resending operations (1020, 1022, and 1024).

In the main processing loop, the sender also checks (1040) whether a timeout condition has been satisfied. For example, the timeout condition is satisfied if a threshold amount of time has elapsed since a flow packet was transmitted without any acknowledgement of receipt of the flow packet by the receiver. In some example implementations, the timeout condition is a fallback condition. A timer for the timeout condition is set to a relatively long duration, so as to allow for OOO delivery and allow for retransmission of dropped packets according to a fast transmission strategy. If the timeout condition is satisfied, however, the sender identifies (1052) one or more unacknowledged flow packets of the flowlet, from the updated tracking window, to resend, and resends (1054) the identified unacknowledged flow packet(s) to the receiver. The sender then continues the main processing loop.

### E. Example Techniques for Fast Retransmission Using EOF Packets.

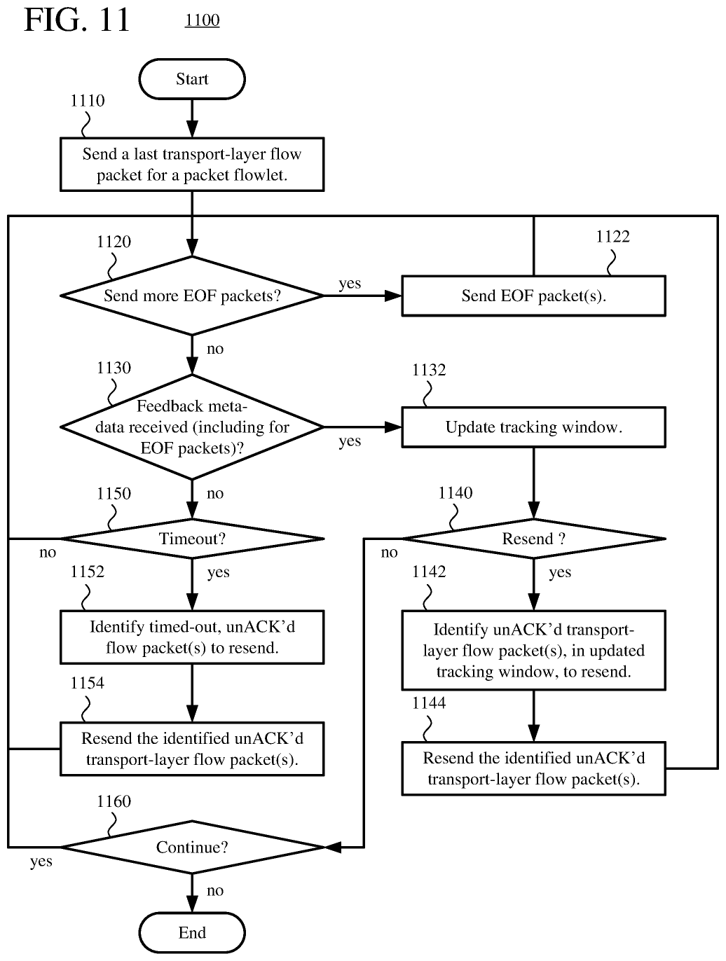

FIG. 11 shows a generalized technique (1100) for delivery of packets according to a reliable transport protocol with fast retransmission using EOF packets. A network interface device, as described with reference to FIG. 1 or otherwise, can perform the technique (1100). The technique (1100) shows operations from the perspective of a sender, which manages delivery of a packet flow according to a reliable transport protocol.

With reference to FIG. 11, the sender sends (1110), to a receiver across a network, a last transport-layer flow packet among multiple transport-layer flow packets for a flowlet. In general, the flowlet is a burst of multiple flow packets, followed by an idle interval. In some example implementations, the flow packets are delivered on multiple paths of the network using multi-path delivery. The multiple paths of the network can be symmetric, in which case the multiple paths have identical length (in terms of the number of multiple hops between endpoints through network switches). Or, the multiple paths of the network can be asymmetric. Alternatively, the flow packets are delivered on a single path of the network using single-path delivery.

The sender then performs operations in a main processing loop. For example, in the main processing loop, the sender can selectively send EOF packets to the receiver, react to feedback metadata from the receiver, and react to timeout events.

After sending the last flow packet of the flowlet but before satisfaction of a timeout condition for the last flow packet, the sender sends one or more EOF packets. In FIG. 11, the sender checks (1120) whether to send more EOF packets. If so, the sender sends (1122) one or more EOF packets to the receiver across the network. The EOF packets can be flush packets, query packets, or some other type of EOF packet. The sender then continues the main processing loop.

In some example implementations, the flow packets and the EOF packet(s) (at least when the EOF packets are flush packets) are ordered by PSN in a packet sequence. In terms of PSN, the EOF packet(s) immediately follow the last flow packet of the flowlet in the packet sequence. The sender can send an initial EOF packet, among the EOF packet(s), right after sending the last flow packet of the flowlet, without sending any other packets between the last flow packet and the initial EOF packet. Depending on implementation, the sender can send the initial EOF packet less than a target time after sending the last flow packet of the flowlet. For example, the target time is a time less than a round trip time expected for the flow packets. Alternatively, the target time is defined in some other way.

Depending on implementation, the sender can selectively send EOF packet(s) or automatically send EOF packet(s). For example, the sender determines a metric that quantifies activity level. The metric can depend on the amount of data ready to send at the sender to the receiver for the given packet flow and/or depend on another factor. The sender compares the metric to a threshold. If the metric satisfies the threshold, the sender sends the EOF packet(s). Otherwise (the metric does not satisfy the threshold), the sender skips sending the EOF packet(s). In this way, the sender can skip sending EOF packets if the network is already busy or likely to be busy, or if the sender will soon send flow packets to the receiver that should trigger feedback metadata. Alternatively, the sender can automatically send at least some EOF packets.

In the main processing loop, the sender also checks (1130) whether any feedback metadata has been received from the receiver, including feedback for EOF packets as well as feedback from flow packets. For example, the feedback metadata is received as one or more ACK packets. The feedback metadata can include ACK metadata and SACK metadata. For a given flow packet, the ACK metadata can indicate receipt, by the receiver, of the given flow packet, and the SACK metadata can indicate receipt, by the receiver, of any of the sent flow packets that is after the given flow packet in a packet sequence. When an earlier flow packet is delayed or dropped, the feedback metadata for EOF packet(s) can include SACK metadata for one or more of the sent flow packets that are after the earlier flow packet in the packet sequence.

If the sender has received feedback metadata, the sender updates (1132) a tracking window based at least in part on the feedback metadata. When the flow packets are delivered using multi-path delivery, the tracking window is an OOO tracking window that tracks n packets, where n is greater than 1. ACK metadata can indicate the start of an updated OOO tracking window. Based on ACK metadata, the sender can move the OOO tracking window forward in time. When the sender has received feedback metadata for EOF packet(s), the sender updates the tracking window based at least in part on the feedback metadata for the EOF packet(s). For example, SACK metadata can indicate which flow packets in the OOO tracking window have been received. Based on SACK metadata, the sender can update the OOO tracking window to indicate OOO receipt of flow packets. When the feedback metadata for EOF packet(s) indicates a given sent flow packet has been received, the sender can update the tracking OOO tracking window by changing an indicator bit for the given sent flow packet.

The sender selectively resends, to the receiver across the network, one or more unacknowledged flow packets among the sent flow packets of the flowlet. The unacknowledged flow packet(s) are indicated as not received in the updated tracking window. For example, the sender evaluates (1140) a condition for fast retransmission using the updated tracking window. The condition can depend on a count of repeated ACK packets or some other threshold for fast retransmission. If the condition for fast retransmission is satisfied, the sender identifies (1142) one or more unacknowledged flow packets of the flowlet, from the updated tracking window, to resend, and resends (1144) the identified unacknowledged flow packet(s) to the receiver. For example, the sender identifies every unacknowledged flow packet of the flowlet according to the updated tracking window, identifies an oldest unacknowledged flow packet of the flowlet in the updated tracking window, or identifies unacknowledged flow packets of the flowlet according to another strategy. Thus, responsive to determining that the condition is satisfied, the sender resends identified unacknowledged flow packet(s) to the receiver. The sender then continues the main processing loop.

When evaluating the condition, the sender may instead determine that the condition is not satisfied. In this case, responsive to determining that the condition is not satisfied, the sender skips resending unacknowledged flow packet(s) of the flowlet to the receiver. At this point, based on the feedback metadata and updated tracking window, the sender can check (1170) whether to continue operations for the packet flowlet. If all flow packets of the flowlet have been acknowledged as received, the sender can stop operations for the packet flowlet. Otherwise, the sender continues the main processing loop.

In the main processing loop, the sender also checks (1150) whether a timeout condition has been satisfied. For example, the timeout condition is satisfied if a threshold amount of time has elapsed since a flow packet was transmitted without any acknowledgement of receipt of the flow packet by the receiver. In some example implementations, the timeout condition is a fallback condition. A timer for the timeout condition is set to a relatively long duration, so as to allow for OOO delivery and allow for retransmission of dropped packets according to a fast transmission strategy. If the timeout condition is satisfied, however, the sender identifies (1152) one or more unacknowledged flow packets of the flowlet, from the updated tracking window, to resend, and resends (1154) the identified unacknowledged flow packet(s) to the receiver. The sender then continues the main processing loop.

In some example implementations, each of the EOF packet(s) is a flush packet having a header and a payload. The payload of the flush packet can be nominal or empty. When the flow packets are delivered using multi-path delivery and the tracking window is an OOO tracking window that tracks n packets, the sender sends up to n EOF packets so as to flush the OOO tracking window. To resend unacknowledged flow packet(s), the sender identifies the unacknowledged flow packet(s) of the flowlet in the updated OOO tracking window and resends the identified flow packet(s). When the flow packets are delivered using single-path delivery and the tracking window is an in-order tracking window, the sender sends a single EOF packet so as to flush the in-order tracking window. To resend unacknowledged flow packet(s), the sender determines that the last flow packet has been delayed or dropped, and resends the last flow packet.

In other example implementations, each of the EOF packet(s) is a query packet having a header and a payload. An indicator in the header of the query packet marks the query packet as a special class of packet that requests delivery state information from the receiver. The payload of the query packet can be nominal or empty. When the flow packets are delivered using multi-path delivery and the tracking window is an OOO tracking window, according to a query interval, the sender periodically sends one of the EOF packets until all of the sent flow packets of the flowlet have been acknowledged as received. For example, the query interval is set to be half the expected round trip time for the flow packets. Alternatively, the query interval is set to have another value.

When the payload of an EOF packet is empty or nominal, the EOF packet(s) do not significantly contribute to network congestion. Alternatively, a given EOF packet can have the payload of a given flow packet, among the sent flow packets of the flowlet, that has not been acknowledged as received. In this case, the feedback metadata can indicate the given flow packet has been received. Or, the feedback metadata can indicate the given EOF packet has been received. Either way, the tracking window is updated by changing an indicator bit for the given flow packet to indicate the given flow packet has been received.

### F. Technical Advantages.

With innovations described herein, a reliable transport protocol includes a mechanism for fast retransmission of packets at the end of a packet flowlet. In example usage scenarios, with the fast retransmission mechanism, a sender can more quickly complete delivery of the packets of a flowlet when one or more flow packets towards the end of the flowlet have been dropped or significantly delayed. The innovations provide several technical benefits, including the following.

First, when packets of a flow are delivered using multi-path delivery, available network bandwidth is more consistently and evenly used, compared to approaches in which packets of a flow are delivered using single-path delivery.

Second, with the fast retransmission mechanism, reliable delivery of all packets for a flowlet can be faster overall, compared to approaches that handle dropped packets towards the end of the flowlet with slower retransmission decisions such as timeout conditions.

Third, the fast retransmission mechanism is implemented as part of a transport protocol, which supports transmission of packets on paths with multiple hops and supports transmission of packets on paths implemented with different types of data link technology. In contrast to approaches that provide for retransmission of packets on a path with a single hop (e.g., for wireless transmission), approaches described herein work for paths with multiple hops per path. Approaches that provide for retransmission of packets at the link layer (for delivery over a single-hop path) typically attempt to mitigate erroneous transmissions and transparently recover from them without affecting higher-level functions of the transport layer, such as flow control. In contrast, approaches described herein can work for different types of data links and can be integrated into higher-level functions of a transport protocol, even when packets of a flow are delivered using multiple-path delivery over multi-hop paths of a network.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. In a computer system, a method of managing delivery of a given packet flow according to a reliable transport protocol, the method comprising:
sending, from a sender to a receiver across a network, a last transport-layer flow packet of a flowlet, wherein the flowlet is a burst of multiple transport-layer flow packets from the given packet flow, followed by an idle interval, the multiple transport-layer flow packets ending with the last transport-layer flow packet;
after the sending the last transport-layer flow packet but before satisfaction of a timeout condition for the last transport-layer flow packet, sending one or more end-of-flowlet (“EOF”) packets;
receiving, at the sender from the receiver, feedback metadata for the one or more EOF packets;
at the sender, updating a tracking window based at least in part on the feedback metadata for the one or more EOF packets; and
selectively resending, from the sender to the receiver across the network, one or more unacknowledged transport-layer flow packets, according to the updated tracking window, among the sent transport-layer flow packets.

2. The method of claim 1, further comprising:
determining a metric that quantifies activity level; and
comparing the metric to a threshold, wherein the sending the one or more EOF packets is contingent on the metric satisfying the threshold.

3. The method of claim 2, wherein the metric depends on amount of data ready to send at the sender to the receiver for the given packet flow.

4. The method of claim 1, wherein the feedback metadata for the one or more EOF packets includes selective acknowledgement metadata for one or more of the sent transport-layer flow packets, wherein the feedback metadata indicates a given sent transport-layer flow packet, among the sent transport-layer flow packets, has been received, and wherein the updating the tracking window includes changing an indicator bit for the given sent transport-layer flow packet.

5. The method of claim 1, wherein each of the one or more EOF packets is a transport-layer flush packet having a header and a payload.

6. The method of claim 5, wherein the reliable transport protocol supports multi-path delivery of the multiple transport-layer flow packets over multiple paths of the network, wherein the tracking window is an out-of-order (“OOO”) tracking window that tracks n packets, n being greater than 1, wherein the sending the one or more EOF packets sends up to n EOF packets so as to flush the OOO tracking window, and wherein the selectively resending includes:
identifying the one or more unacknowledged transport-layer flow packets in the updated OOO tracking window; and
resending the one or more identified transport-layer flow packets.

7. The method of claim 5, wherein the reliable transport protocol supports single-path delivery of the multiple transport-layer flow packets over a single path of the network, wherein the tracking window is an in-order tracking window, wherein the sending the one or more transport-layer EOF packets sends a single EOF packet so as to flush the in-order tracking window, and wherein the selectively resending includes:
determining that the last transport-layer flow packet has been delayed or dropped; and
resending the last transport-layer flow packet.

8. The method of claim 5, wherein the payload of the flush packet is nominal or empty.

9. The method of claim 1, wherein each of the one or more EOF packets is a transport-layer query packet having a header and a payload, and wherein an indicator in the header of the query packet marks the query packet as a special class of packet that requests delivery state information from the receiver.

10. The method of claim 9, wherein the reliable transport protocol supports multi-path delivery of the multiple transport-layer flow packets over multiple paths of the network, wherein the tracking window is an out-of-order (“OOO”) tracking window that tracks n packets, n being greater than 1, and wherein the sending the one or more EOF packets periodically sends, according to a query interval, one of the one or more EOF packets until all of the sent transport-layer flow packets have been acknowledged as received.

11. The method of claim 10, wherein the query interval is set to be half an expected round trip time for the multiple transport-layer flow packets.

12. The method of claim 9, wherein the payload of the query packet is nominal or empty.

13. The method of claim 1, wherein the multiple transport-layer flow packets and the one or more EOF packets are ordered by packet sequence number in a packet sequence, the one or more EOF packets immediately following the last transport-layer flow packet in the packet sequence.

14. The method of claim 1, wherein the sender sends an initial EOF packet among the one or more EOF packets less than a target time after sending the last transport-layer flow packet, and wherein the target time is less than a round trip time expected for the multiple transport-layer flow packets.

15. The method of claim 1, wherein a given EOF packet, among the one or more EOF packets, has a payload of a given sent transport-layer flow packet among the sent transport-layer flow packets, that has not been acknowledged as received, wherein the feedback metadata indicates the given sent transport-layer flow packet or the given EOF packet has been received, and wherein the updating the tracking window includes changing an indicator bit for the given sent transport-layer flow packet.

16. The method of claim 1, wherein the selectively resending includes:
evaluating a condition using the updated tracking window; and
responsive to determining that the condition is satisfied, resending the one or more unacknowledged transport-layer flow packets from the sender to the receiver.

17. The method of claim 1, wherein the selectively resending includes:
evaluating a condition using the updated tracking window; and
responsive to determining that the condition is not satisfied, skipping resending the one or more unacknowledged transport-layer flow packets from the sender to the receiver.

18. One or more non-transitory computer-readable media having stored thereon computer-executable instructions for causing one or more processing units, when programmed thereby, to perform operations to manage delivery of a given packet flow according to a reliable transport protocol, the operations comprising:
sending, from a sender to a receiver across a network, a last transport-layer flow packet of a flowlet, wherein the flowlet is a burst of multiple transport-layer flow packets from the given packet flow, followed by an idle interval, the multiple transport-layer flow packets ending with the last transport-layer flow packet;
after the sending the last transport-layer flow packet but before satisfaction of a timeout condition for the last transport-layer flow packet, sending one or more end-of-flowlet (“EOF”) packets;
receiving, at the sender from the receiver, feedback metadata for the one or more EOF packets;
at the sender, updating a tracking window based at least in part on the feedback metadata for the one or more EOF packets; and
selectively resending, from the sender to the receiver across the network, one or more unacknowledged transport-layer flow packets, according to the updated tracking window, among the sent transport-layer flow packets.

19. A network interface device configured to perform operations to manage delivery of a given packet flow according to a reliable transport protocol, the operations comprising:
sending, from a sender to a receiver across a network, a last transport-layer flow packet of a flowlet, wherein the flowlet is a burst of multiple transport-layer flow packets from the given packet flow, followed by an idle interval, the multiple transport-layer flow packets ending with the last transport-layer flow packet;
after the sending the last transport-layer flow packet but before satisfaction of a timeout condition for the last transport-layer flow packet, selectively resending one or more of the sent transport-layer flow packets that have not yet been acknowledged as received according to a tracking window;
receiving, at the sender from the receiver, feedback metadata;
at the sender, updating the tracking window based at least in part on the feedback metadata; and
selectively resending, from the sender to the receiver across the network, one or more unacknowledged transport-layer flow packets, according to the updated tracking window, among the sent transport-layer flow packets.

20. The network interface device of claim 19, wherein the reliable transport protocol supports multi-path delivery of the multiple transport-layer flow packets over multiple paths of the network, wherein the tracking window is an out-of-order (“OOO”) tracking window that tracks n packets, n being greater than 1, and wherein the one or more of the sent transport-layer flow packets that have not yet been acknowledged as received are resent so as to fill any holes in the out-of-order tracking window more quickly.
